(19) United States
(12) Patent Application Publication
(10) Pub. No.: US 2013/0123025 A1
(43) Pub. Date: May 16, 2013

(54) GAME-BASED ADVERTISING SYSTEM AND METHOD

(71) Applicants: Richard Albert Ferdinand, Old Tappan, NJ (US); Kathryn Ellen Ferdinand, Old Tappan, NJ (US); Wynne Ellen Ferdinand, Old Tappan, NJ (US); Richard Alexander Ferdinand, Old Tappan, NJ (US); Timothy Edward Ferdinand, Old Tappan, NJ (US)

(72) Inventors: Richard Albert Ferdinand, Old Tappan, NJ (US); Kathryn Ellen Ferdinand, Old Tappan, NJ (US); Wynne Ellen Ferdinand, Old Tappan, NJ (US); Richard Alexander Ferdinand, Old Tappan, NJ (US); Timothy Edward Ferdinand, Old Tappan, NJ (US)

(21) Appl. No.: 13/729,359

(22) Filed: Dec. 28, 2012

Related U.S. Application Data
(63) Continuation of application No. 13/442,941, filed on Apr. 10, 2012.
Application No. 13/442,941 is a continuation of application No. 12/405,486, filed on Mar. 17, 2009, now abandoned.
(60) Provisional application No. 61/143,239, filed on Jan. 8, 2009.
(60) Provisional application No. 61/081,879, filed on Jul. 18, 2008.
(60) Provisional application No. 61/037,812, filed on Mar. 19, 2008.

(51) Int. Cl. G06Q 30/02

(52) U.S. Cl. CPC G06Q 30/0277
USPC 463/48

(57) ABSTRACT

A game-based system and method are provided which employ a central system controller and a plurality of interactive display terminals geographically dispersed from the system controller. Players interact with the display terminals via respective, anonymous recognition codes (ARCs). The display terminals are configured to record a session data set on each player interaction session therewith via the players' respective ARCs. The session data set includes the player's ARC, a location-identifier of the display terminal, a reward selected by the player from multiple rewards of a displayed reward and advertisement data set and an advertisement selected by the player from multiple advertisements of the data set. Players access data of their session data set via a personal electronic compartment accessible through an internet-accessible web server of the controller. The personal electronic compartment is automatically initiated responsive to first use of the player's ARC with one of the interactive display terminals.

### CROSS-REFERENCE TO RELATED APPLICATIONS

This application is a continuation of U.S. patent application Ser. No. 13/442,941 entitled “Game-Based Advertising System and Method” filed Apr. 10, 2012, which is a continuation of U.S. patent application Ser. No. 12/405,486 entitled “Game-Based Advertising System and Method” filed Mar. 17, 2009, and claims benefit to U.S. Provisional patent application Ser. No. 61/037,812, filed Mar. 19, 2008, entitled “Game-Based Advertising System with Geographically-Localized Vendor and Customer Correlation”, U.S. Provisional patent application Ser. No. 61/081,879, filed Jul. 18, 2008, entitled “Game-Based Advertising System with Geographically-Localized Vendor and Customer Correlation”, and U.S. Provisional patent application Ser. No. 61/143,239, filed Jan. 8, 2009, entitled “Game-Based Advertising System with Geographically-Localized Vendor and Customer Correlation”, each of which is hereby incorporated herein by reference in its entirety.

### TECHNICAL FIELD

This invention relates in general to the field of advertising, and more specifically, to a multi-media game-based advertising system and method utilizing player anonymity.

### BACKGROUND OF THE INVENTION

One common method of acquiring new customers is through marketing efforts, such as advertising and promotions. Advertisements and promotions can be disseminated through various mediums, such as the internet, e-mail, television, newspapers, magazines, billboards, etc. The most valuable type of marketing is “targeted marketing” which means that instead of marketing to the general public, marketing efforts are focused on a specific audience of consumers that are already known to have an interest in goods and services similar to those offered, therefore increasing the probability that the consumers will visit the website, respond to the e-mail, or otherwise make a purchase. It has been found that competition for obtaining consumer e-mail addresses for the purpose of effective target marketing, has emerged as a principle business objective.

In addition, customer retention is an important aspect of any business. Once consumers have visited a website, made a purchase, or otherwise interacted with a company, a positive experience is one way to ensure that the customer will do business again with the company. Providing incentives (such as discounts, customer loyalty programs, and fun or entertaining experiences) are effective ways of promoting a positive experience and retaining customers. Essentially, if a customer thinks they are “getting a deal” or otherwise having a pleasurable experience doing business with the company, they will continue to do so, and possibly recommend the company to others.

### SUMMARY OF THE INVENTION

Provided herein therefore, in one aspect, is a system comprising a system controller, which includes memory, at least one processor, and an internet-accessible web server servicing an internet-accessible website. The system controller is configured for automatic communications with at least one interactive display terminal disposed geographically remote from the system controller. Responsive to a player's first interaction with the interactive display terminal using an anonymous recognition code of a plurality of predefined anonymous recognition codes, the system controller automatically initiates a personal electronic compartment accessible through the internet-accessible web server corresponding to the player's anonymous recognition code, and associates with this personal electronic compartment a location identifier of the interactive display terminal at which the anonymous recognition code was first used. The personal electronic compartment is player accessible via the internet through the internet-accessible website serviced by the internet-accessible web server of the system controller. In one embodiment, the system is a game-based advertising system, and the interactive display terminal is configured to present, responsive to actuation thereof by the player's anonymous recognition code, a reward and advertisement data set. The player interacts with the terminal and selects one reward and one advertisement of the reward and advertisement data set using the player's anonymous recognition code.

In another aspect, a system is provided which includes an interactive display terminal configured for player interaction therewith via an anonymous recognition code of a plurality of predefined anonymous recognition codes. The interactive display terminal includes a display screen and an input device configured to recognize the player's anonymous recognition code for player interaction with the interactive display terminal. The player communicates with the input device of the interactive display terminal using only the player's anonymous recognition code. The interactive display terminal is configured for player selection of a reward employing the input device and the player's anonymous recognition code, and for player selection of an advertisement using the input device and the player's anonymous recognition code. The reward is one reward of multiple rewards of a reward and advertisement data set presented to the player on the display screen and the advertisement is one advertisement of multiple advertisements of the reward and advertisement data set presented to the player. Responsive to the player's selection of the reward and selection of the advertisement, the interactive display terminal automatically associates the player's anonymous recognition code with the selected reward in a session data set, and displays for a period of time the selected advertisement on the display screen.

In still another aspect, a system is provided which includes a plurality of interactive display terminals and a central system controller. The plurality of interactive display terminals are configured for players to interact therewith via respective anonymous recognition codes of a plurality of predefined anonymous recognition codes. Each interactive display terminal of the plurality of interactive display terminals is further configured to record a session data set on a player's interaction therewith using the player's respective anonymous recognition code. The session data set includes the player's anonymous recognition code, a location-identifier of the interactive display terminal, a reward selected by the player from multiple displayed rewards of a reward and advertisement data set and an advertisement selected by the player from multiple displayed advertisements of the reward and advertisement data set. The central system controller includes an internet-accessible web server servicing an internet-accessible website. The central system controller and the plurality of interactive display terminals are configured for automatic communications therebetween. Session data sets accumulated at the plurality of interactive display terminals are automatically transferred to the central system controller, and players access data of their session data sets via respective personal electronic compartments accessible through the internet-accessible website serviced by the internet-accessible web server.

In a further aspect, a method is provided which includes: providing a central controller comprising memory and at least one processor, the central system controller including an internet-accessible web server configured to service an internet-accessible web site, and the central system controller being configured for automatic communications with a plurality of interactive display terminals; geographically dispersing the plurality of interactive display terminals, wherein each interactive display terminal is configured to record a session data set on each player interaction session therewith via a respective anonymous recognition code of a plurality of predefined anonymous recognition codes, each session data set comprising the player's anonymous recognition code, a location identifier of the interactive display terminal, a reward selected by the player from multiple displayed rewards of a reward and advertisement data set and an advertisement selected by the player from multiple displayed advertisements of the reward and advertisement data set; and wherein session data sets accumulated by the plurality of interactive display terminals are automatically transferred to the central system controller, and wherein players access data of their session data sets via respective, personal electronic compartments corresponding to their anonymous recognition codes and accessible through the internet-accessible web server of the central system controller.

Further, additional features and advantages are realized through the techniques of the present invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is an overview of one embodiment of a system, in accordance with an aspect of the present invention;

FIG. 2 is a partial depiction of a city map illustrating geographic disbursement of multiple interactive display terminals across the city, in accordance with an aspect of the present invention;

FIG. 3 is a block diagram of one embodiment of an interactive display terminal, and a player's interaction therewith employing an anonymous recognition code (ARC) card, in accordance with an aspect of the present invention;

FIG. 4 is a flowchart of one embodiment of logic for periodically updating a reward and advertisement data set at the interactive display terminal(s), in accordance with an aspect of the present invention;

FIG. 5 illustrates a display screen of an interactive display terminal and an input device through which the player communicates with the interactive display terminal using only the player's ARC card, and showing multiple rewards and multiple advertisements of a reward and advertisement data set displayed simultaneously in the display screen for player selection as described herein, in accordance with an aspect of the present invention;

FIG. 6 is a flowchart of one player interaction process with an interactive display terminal, in accordance with an aspect of the present invention;

FIG. 7A depicts one embodiment of a terminal's display screen content at player initiation of an interactive session using the player's anonymous recognition code, in accordance with an aspect of the present invention;

FIG. 7B illustrates one embodiment of display screen content responsive to player initiation of an interactive session, wherein the interactive display terminal sequentially highlights for a first time period each reward of the multiple rewards in the displayed reward and advertisement data set, in accordance with an aspect of the present invention;

FIG. 7C illustrates the display screen content of FIG. 7B, with the player's anonymous recognition code being employed to select reward B when highlighted as illustrated, in accordance with an aspect of the present invention;

FIG. 7D illustrates an increase in form factor of reward B once selected, and the beginning of the terminal's interactive display sequentially highlighting of each advertisement of the multiple displayed advertisements for a second time period until player selection of a highlighted advertisement is made using the player's ARC card, in accordance with an aspect of the present invention;

FIG. 7E depicts the display screen content of FIG. 7D, with highlighting of a second advertisement of the multiple advertisements, in accordance with an aspect of the present invention;

FIG. 7F depicts the display screen content of FIGS. 7C & 7D, with highlighting of a third advertisement of the multiple advertisements, in accordance with an aspect of the present invention;

FIG. 7G depicts the display screen content of FIGS. 7C-7F, with highlighting of a fourth advertisement, and player selection of the fourth advertisement while highlighted using the player's ARC card, in accordance with an aspect of the present invention;

FIG. 7H depicts an enlarged form factor display of selected advertisement 4 to the full dimensions of the display screen for a defined time period, in accordance with an aspect of the present invention;

FIG. 71 depicts one embodiment of display screen content subsequent to display of the selected advertisement, and illustrating player sign-off using the player's ARC card, in accordance with an aspect of the present invention;

FIG. 8 is a flowchart of one embodiment of processing for accumulating and forwarding session data sets on player-interactive sessions with the interactive display terminal(s), in accordance with an aspect of the present invention;

FIG. 9 depicts one embodiment of a system comprising multiple interactive display terminals (and personal computers) geographically dispersed from a central system controller and communicating with the central system controller across a network, such as the internet, in accordance with an aspect of the present invention;

FIG. 10 depicts a process diagram illustrating transfer of data between a reward and advertisement server, the interactive display terminal(s), a data storage server and an internet-accessible web server of a system, in accordance with an aspect of the present invention;

FIG. 11 is a flowchart of one process embodiment of a player accessing the player's personal electronic compartment (separate from the interactive display terminal) using the player's anonymous recognition code or an identification number associated with the player's anonymous recognition code, in accordance with an aspect of the present invention; and

FIG. 12 depicts one embodiment of a computer program product incorporating one or more aspects of the present invention.

### DETAILED DESCRIPTION OF THE INVENTION

The dynamics of changing consumer attention patterns are simulating a large-scale shift of advertising expenditures away from one-way media, such as newspapers. The first major wave of this shift has favored online advertising. As technology has improved, advertisers have required more comprehensive and precise monitoring, reporting and measurement (metrics) of advertising effects and responses. These same metrics have indicated that advertisers should not abandon offline, traditional advertising, or ignore placed-based media (such as signage). A new demand on advertisers is to coordinate advertising campaigns across many lines of media in order to influence purchase decisions in a fashion that follows the evolving channelization of consumer attention patterns in step with: the dynamic changes in current popular communications technologies, and the adoption of these technologies as important communications, entertainment, research, education and social networking tools.

The dynamics of changing consumer attention patterns also require advertisers to interact with highly exploratory consumers who are increasingly apt: (1) to experiment with new technologies and opportunities; (2) to continuously share new information with known and unknown contacts; and (3) to communicate regularly with social and commercial contacts that are perceived by consumers to be immediately “present”, either in a personal physical environment or in a personal electronic environment. In practice, these two types of personal consumer environments often co-exist in time and space as consumers often simultaneously communicate with contacts who are physically present and with contacts who are “virtually present” via various electronic communication devices.

Within this environment, provided herein are systems and methods that enable advertisers to acquire and maintain new consumer relationships on favorable economic terms. The customer acquisition process begins when a consumer (herein referred to as a “player”) first interacts with digital signage (or, more generally, “an interactive display terminal”) located, for example, at a gathering place or high foot traffic location. The terminal (or signage) is typically placed where targeted economic or demographic populations gather or pass by on foot in large numbers. The player may view the signage, thereby being effected by an impression, or, more pertinently, may interact with the signage via an interactive digital game (referred to herein as “The AdverPrizing Gₐₘₑ™” or “the game”). The game or games are operated and maintained by a system operator. The player does not provide any personal information to the system or to the system operator. Thus, the player remains anonymous. Further, the game is free. The player is not required to make any payments or to make any purchases in connection with playing The AdverPrizing Game™. The player can interact with the game via numerous possible signaling devices. It is expected that the most widely used signaling device will be in the approximate shape and form of a credit card and will be equipped so that the player can interact with the digital signage on a non-contact basis. Depending on the implementation, “non-contact” playing may occur at distances up to approximately 20 feet and includes the ability to play the game through a window.

The display space on the digital terminal will (in one embodiment) be divided into panels, subdivided into reward panels and advertising panels. In fact, all panels serve as advertising media. However, the reward panels serve a double function as exhibits of potential rewards for winners of the game, and also as advertisements for the products, services or offerings of the companies that are represented. The system highlights panels to indicate that they are temporarily active and the player indicates a choice of a highlighted panel by use of the player's signaling device. A sequential combination of choice of an active reward panel and choice of an active ad panel by a player will (in one embodiment) enter the player into a scheduled drawing for the reward. The combination of these two interactive choices indicate that the player has played the game. The winning player is typically not required to make any form of payment to the system or to the system operator in connection with winning or receiving the reward.

At the time when the anonymous player plays the game for the first time, the system's categories of competitive advantages may include: 1) cost; 2) time-sensitive control of message and media content and appearance; 3) test, measurement, monitoring and reporting functions including real time capabilities and continuous update capabilities; and 4) novel usage of enticements including proprietary games and game formats that attract players to interact with advertisements displayed on the interactive display terminal, and enticements and methods that encourage and “train” players to follow up with repeated visits to the system website(s) and other functions.

It is a strategic goal of the invention that an advertiser achieves durable multi-channel interactive access to an anonymous player responsive to the player first playing the game. The automatic activation of a personal electronic compartment for the player within the pertinent system website and the activation of a personal direct linkage display and holding functions for the player responsive to the player first playing the game at a remote terminal provides advertisers with unique integrated interactive follow-up capabilities with each player that are designed to act together to produce novel functionality, and, to produce competitive advantages for the advertisers versus other methods of advertising.

As explained further below, categories of competitive advantages of the system and method presented herein include:
1. Cost advantages in many advertising categories;
2. Time-sensitive digital control of message and media content and appearance across media platforms;
3. Test, measurement, monitoring and reporting functions including real time and continuous update capabilities;
4. Enticements including proprietary games and game formats that attract players to interact with advertisements displayed on the interactive display terminal and enticements and methods that systematically encourage and train players to follow-up with repeated visits to the system website(s) where additional enticements and opportunities for engaging interactions with advertisements are available;
5. Utilization by the players of novel and entertaining signaling methods, technologies and devices to interact with the interactive display terminal and that may attract others to imitate the players and to play the game;
6. Personal privacy and security offered to players who may use all functions of the system while remaining anonymous to the system and to the system operator;
7. Utilization of embedded advertiser web sites, embedded instant messaging connections and other similar functions that permit players to leave the system website and to enter advertiser websites, online ordering sites, and other communications enabled platforms operated and maintained by advertisers that, in turn, permit the players to interact directly on an anonymous (or a non-anonymous) basis with advertisers;
8. Images and architectures associated with system websites that provide players with a proprietor's sense of owning and occupying his or her “own” virtual properties (i.e., the personal electronic compartment(s)) that are offered and maintained by the system;
9. Automatic creation and activation of personal electronic compartments for the players within the pertinent system website;
10. Ability to create additional personal electronic compartments for self-use, additional family members and invitees;
11. Automatic creation and activation of personal electronic direct linkage display and holding functions for each of the players;
12. Automatic usage of anonymous recognition codes (ARC's), mirror codes and sister codes that protect the player from intrusive messaging, spam and sale or sharing of personal information with outsiders;
13. Continuous periodic refreshment of rewards that are available to players of the game; availability of occasional “pop-up” rewards that add to the entertainment value of the games; and, availability of occasional “super rewards” that are simultaneously available to players at multiple places and locations;
14. Granular management of time slots that are available for advertisements and rewards in a fashion that permits insertion of other types of media such as announcements or non-interactive panels in the ad panel and reward panel spaces;
15. On-demand networked management of all screen and panel content at granular-to-full screen and panel levels, including preemptive networked prevention of undesirable content;
16. Networked management of expansion of ad, reward and message images to full screen size to capture and focus viewer(s)' attention for brief periods of time;
17. Network recognition of players via their individual anonymous recognition codes (ARCs) or associated identification numbers;
18. Issuance of temporary ARCs for special applications such as for hotel guests or for parties;
19. Branding of ARCs;
20. Utilization of ARCs in connection with reward systems wherein reward “points” are accumulated;
21. There are no sign-up procedures required, or even available, to play the game, and therefore to enjoy the benefits of the system;
22. Integrated continuity of message in form and appearance across multiple media formats such as interactive display terminal(s), within the system website and within digital electronic direct linkage displays accessible through the system website;
23. Persistence of message via repeated exposures on multiple digital place-based signs, in multiple locations, in selected micro-targeted audience areas and within prescribed time frames; and
24. Valuable implicit demographic and income strata information and related data that are garnered in connection with the physical location(s) where the games are played.

Rewards and new offerings occur regularly at the interactive display terminals. Additional rewards, offerings and enticements also appear at the player's personal electronic compartment, and at the player's private personal electronic direct linkage display. Features of the game encourage players to routinely access updated information and to seek new opportunities at their personal compartment(s).

The system is designed to serve the players with brief periods of entertainment and exposure to engaging market knowledge. Each player can access this knowledge at the interactive display terminal installations, and historical session information via internet connection to the system's website.

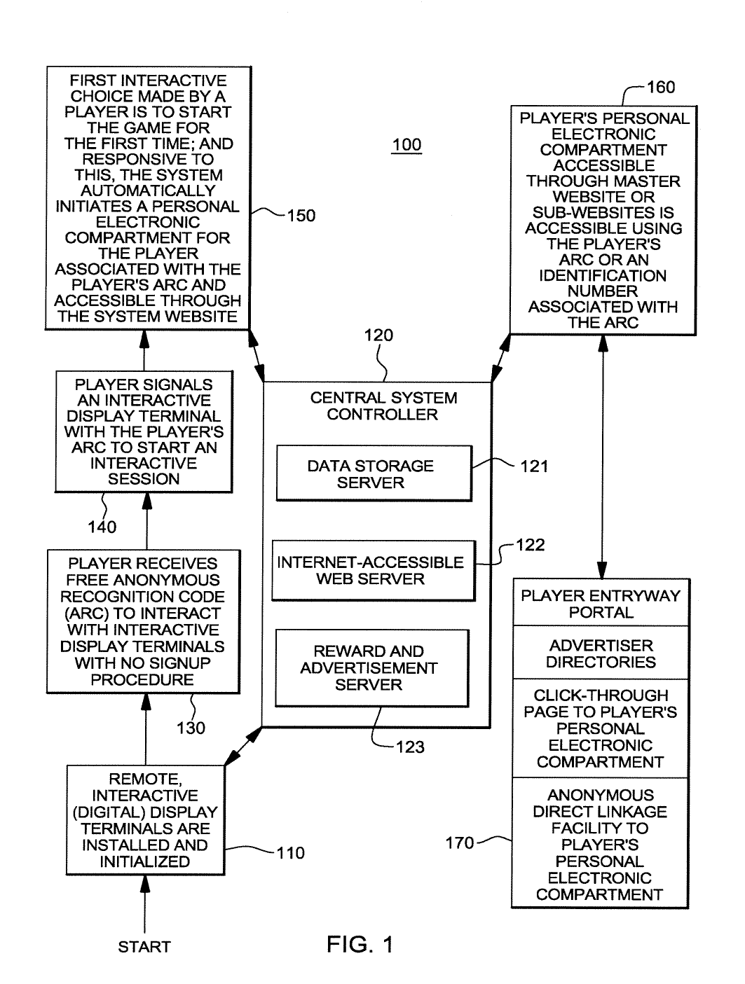

With the above overview, FIGS. 1-12 illustrate one detailed embodiment of a game system and method, in accordance with an aspect of the present invention.

Referring first to FIG. 1, a system 100 is presented which is designed to create a novel cross-media advertising experience for ad viewers which utilizes techniques for: (1) reinforcing impressions and memories imprinted on a player as an ad viewer; and (2) achieving a high standard of continuity-of-message via interactivity between and among location-based, interactive display terminals in high foot traffic areas and related advertisements, activities, enticements and rewards that may be accessed by the players on numerous types of media platforms (such as for example, via the internet, television, electronic direct mail, cell phones, etc.). The system implements methods and enticements to stimulate cross-media advertising message migration in pre-existing familial, social, neighborhood and economic human networks.

As illustrated in FIG. 1, one or more location-based (i.e., remote), interactive display terminals are provided, installed and initialized 110. The interactive display terminal, which in one embodiment, may comprise computer-based digital signage, is delivered (in one embodiment) in a ready condition, only needing to be plugged into a conventional electrical power outlet to begin service. The interactive display terminal may be indoors, outdoors, fixed or mobile, or may be freestanding, available at a kiosk, hung on a wall in a fashion of a picture or painting, or may be suspended overhead to accommodate users who are in line or who are in crowded areas. It is generally desirable to place the terminal where a player can be viewed by several onlookers. This will result in more viewers simultaneously watching the displayed advertisements during each interactive session.

It is also a design object of the invention that many of the onlookers will become engaged with the advertisements as though they were vicarious players of the game. This design element also encourages new viewers to learn by imitation how to start and play the game, and encourages curiosity of other prospective viewers and passer-bys who are interested to learn what is capturing the attention of the active player, and already engaged onlookers. This effect is particularly appealing to advertisers when the game is played by a pedestrian wherein the pedestrian is playing on a non-contact basis inward looking through, for example, a store or restaurant window. This built-in passive recruitment of onlookers and “eavesdroppers” is a result of the system described herein, and can produce a multiplier effect on the audience size that is available to advertisers.

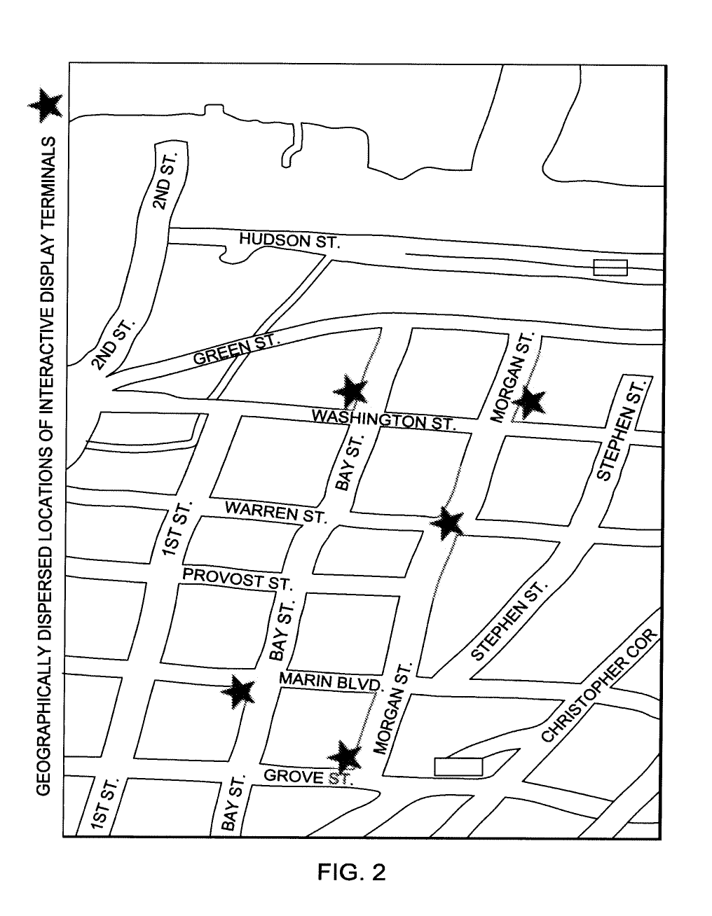

FIG. 2 is a partial map of a city street-scope illustrating geographic disbursement of a plurality of interactive display terminals throughout the city. As explained further herein, each terminal is assigned a location identifier which, combined with knowledge of terminal placement, allows the system to identify the type of location, as well as the actual geographic location of the terminal which the player is interacting with. This location identifier forms part of the data set of information that is accumulated by the terminal and retained within the central system controller, described below.

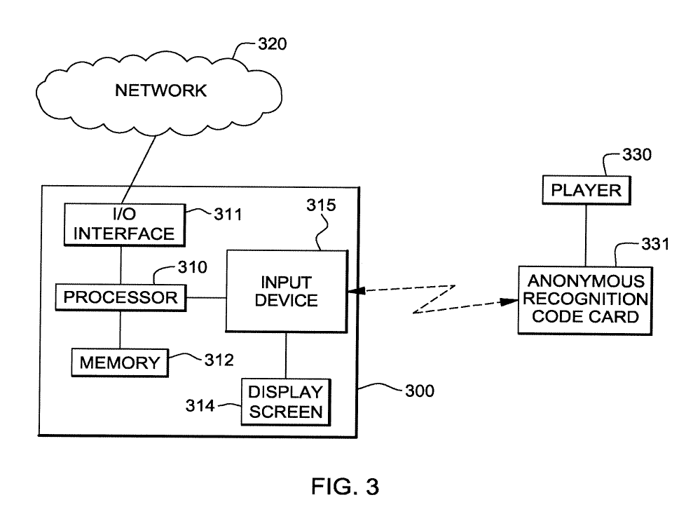

FIG. 3 depicts one embodiment of an interactive display terminal 300, in accordance with an aspect of the present invention. This interactive display terminal comprises a computer system such as referenced below, which includes a processor 310, input/output interface 311 coupling interactive display terminal 300 to a network 320, such as the internet, memory 312, and a display screen 314. Additionally, processor 310 is coupled to an input device 315, also referred to herein as a selection mechanism. Input device 315 is selected to facilitate a player's 330 communication (in one embodiment, wirelessly) therewith using the player's anonymous recognition code (ARC) card 331. As explained further below, the communications medium interfacing the player's ARC card with input device 315 may vary depending on the implementation. For example, the communications medium might be radio frequency, with the input device being an RFID reader, and the ARC being embedded in an RFID card that is manipulated by the player to bring the card within a predefined range of the RFID reader in order to interact with the interactive display terminal. In this embodiment, radio frequency signals are employed by the RFID reader in reading presence of the ARC, and thus depending on the interaction sequence of the session, sensing initiation, selection within or termination of a session, as explained further below. Other known communication technologies may alternatively, or in combination, be employed. For example, acoustic wave identification could be used, or optical identification. In an optical identification implementation, the input device might comprise an optical reader, and the ARC might be implemented, for example, as a bar code or other optically-readable micro-code.

By way of example, the location-based interactive display terminal may be implemented using an iMac® computer, offered by Apple Computer, Inc., of Cupertino, Calif., such as an iMac® 7.1 model, which includes a large, 24 inch display screen. In addition, one or more input devices, such as described above, would be integrated with the computer within the terminal.

As illustrated in FIG. 1, the interactive display terminal (such as terminal 300 in FIG. 3) is in communication with a central system controller 120 of system 100. Central system controller 120 may be located within a secure remote data center environment, and comprise, in the example illustrated, a data storage server 121, an internet-accessible web server 122 and a reward and advertisement server 123. Central system controller 120 sends messages to the interactive display terminals, receives messages from the terminals and collects session data sets from the terminals accumulated on the interactive player sessions, as explained further below. Initially, central system controller 120 downloads display screen images, content and operational instructions to the newly-initialized, interactive display terminals 110. These display screen images include one or more reward and advertisement data sets to be displayed.

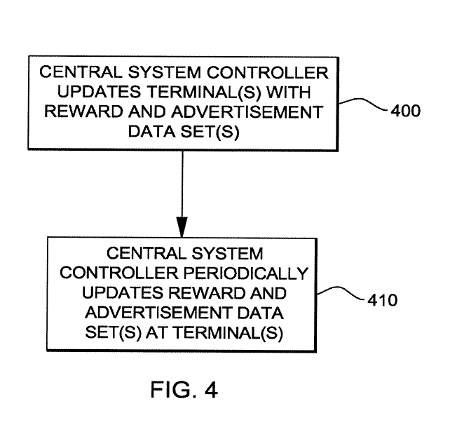

As illustrated in FIG. 4, initialization of an interactive display terminal includes providing the terminal with a computerized reward and advertisement data set for display by the terminal 400. This data set is provided by the central system controller and may be resident on the reward and advertisement server of the central system controller. Thereafter, the central system controller periodically updates the reward and advertisement data set 410 for the terminal(s). For example, once a day, once a week, etc., the reward and advertisement data set may be changed by the controller for a given interactive display terminal. Further, reward and advertisement data sets may be directed to specific interactive display terminals based, for example, on the terminals' location(s) (employing the terminal's location identifier), and using panel identification numbers for each reward and advertisement data set, which may include reward and advertisement identification numbers, a start date and an end date for display of the data set.

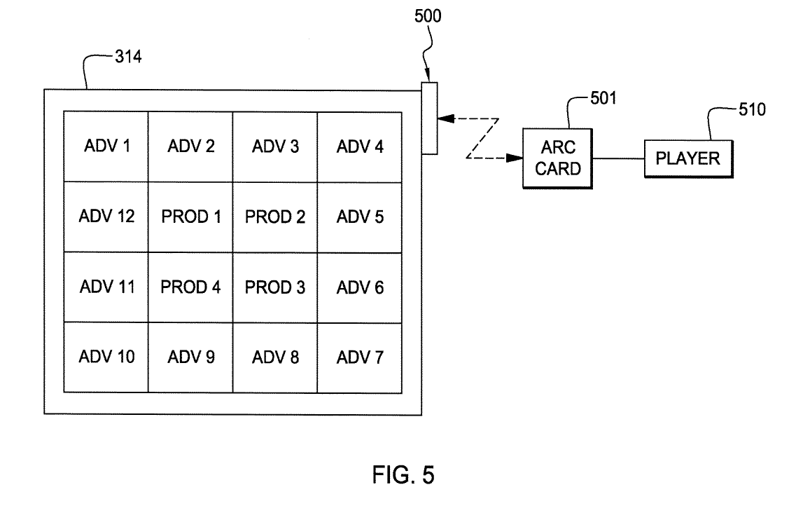

FIG. 5 depicts one embodiment of a display screen 314 presenting an initial reward and advertisement data set. In this embodiment, a single display screen is illustrated wherein a central portion of the display screen includes four panels with product rewards, labeled PROD1, PROD2, PROD3 and PROD4, and a perimeter of the display screen includes twelve advertisement panels, labeled ADV1-ADV12, for player-selection, as explained further below. In this embodiment, the terminal's input device 500 is assumed to comprise an RFID proximity reader, with the ARC card comprising an RFID card 501 which is configured with a predefined anonymous recognition code capable of radio frequency identification. RFID card 501 may be manipulated by a player 510 during the player's interactive session with the terminal to communicate with the terminal, as explained further below. Note that, depending on the technology, the sensor(s) embedded within the interactive display terminal (that is, as part of the input device) may be enabled to read tags on ARC devices at a selected distance from the interactive display terminal (or more particularly, from the input device) and to detect signals related to usage of the device by a player within that distance. In one embodiment, wireless technology is employed to both, initiate and participate in the player interactive session, as well as to communicate between the interactive display terminal and the central system controller. By way of example, the wireless connection between the interactive display terminal and the central system controller might be enabled by a Verizon® EVDO card for 3G internet services. Other technologies, including hard-wired connections, may be employed as desired.

As shown in FIG. 1, the player receives a free anonymous recognition code card to interact with the interactive display terminal(s) with no sign-up procedure 130. This is significant. There is no sign-up procedure required, or even available, to interact with the game system. This point is valuable in a business-building context, and represents a significant commercial value and competitive advantage. The absolute value and the competitive value of the system are directly related to the number of players that use the system and the speed at which usage volume builds in any new service area (e.g., neighborhood, financial district, business district, or other venue). Sign-up procedures are an impediment to usage. Thus, the system presented herein eliminates this impediment. As explained further below, this avoidance of sign-up procedures is combined with the above-noted, automatic initiation of a player's personal electronic compartment in cyberspace, responsive to the player initially interacting with the system through one of the remote terminals. This automatic initiation process enhances the capabilities and competitive advantages for micro-targeting of advertising audiences via the system, and communicating in a stimulating, novel fashion with the audiences.

As noted, the ARC card (or more generally, device) may take various embodiments. In one embodiment, a wallet-sized plastic card, similar in size and shape to a conventional credit card is provided. The ARC card may be associated with the venue at which it was originally issued. That is, the interactive display terminal retains a location identifier which is associated with the initial usage of the card and provided to the player's personal electronic compartment initialized in cyberspace. Thus, the system (and therefore the advertiser(s)) has implicit knowledge about the likelihood of many demographic characteristics for the group of ARC card holders who are associated with a particular venue. The system can also be configured with implicit knowledge about local weather patterns, important local events, normal local dress codes and special neighborhood characteristics, such as “an art district” or “a government center area”. The number of competitive advantages that can be created from this implicit knowledge is significantly increased by the automatic initiation of the player's personal electronic compartment at the internet-accessible website of the central system controller response to the player initially interacting with the system via one of the interactive display terminals, and by the provision of an anonymous direct linkage facility to the player's personal electronic compartment. Thus, instead of a passing impression only each time the new player plays the game, the advertisers have an automatic mechanism to follow-up with the player and to create a lasting advertiser/player (or seller/buyer) relationship. Temporary cards may also be issued for special purposes. Temporary cards are defined as cards that automatically expire from the system and are erased from the system on a specific date. The term “expire from the system” means that the temporary card is deactivated. The term “erased from the system” means that (for example) a facial image and associated records of time/date/location information for individuals may be deleted from the system records, with the associated personal electronic compartments in cyberspace erased.

When the ARC card is used by a player during an interactive session, it is generally desirable for the card to be used in a range of, for example, one to three feet from the display screen of the interactive display terminal, that is, assuming that the display screen is a conventional computer screen size. When larger distances are involved, the important advertising, branding and memory impression effects of the system may be degraded due to the loss of a sense of intimacy with the information items that are displayed on the display screen and loss of a sense of intimate personal privacy that occurs when the player is interacting with the display screen at shorter distances. Depending again on the size of the screen, the distance of the player from the display screen can thus be significant because humans are intrinsically sensitive and potentially reactive to persons, objects or activities in their “personal space”. The range of high sensitivity varies, but sensitivity and potential reactivity is generally most readily stimulated within a range of distances (from display screen to player) of one to three feet. Acuity of vision with respect to color, shape, brightness and detail are generally a function of the size of the image and the distance of the viewer from the image. For advertising and branding purposes, a sharp, close image is more valuable than an indistinct, more distant image. A close image may effectively fill the entire field of view of an observer, and thus be a single object of visual attention for a brief period of time.

As noted, other forms of anonymous recognition code to input device communication may be employed in a player-interactive session. For example, an optically-readable label comprising the ARC may be attached to a wireless phone or other personal device. This label may contain sufficient ARC information to play the game, and may be used instead of the ARC card. There are many other alternatives that may be used for anonymous interaction with the interactive display terminal, in accordance with the concepts described herein. For example, as a further variation, optically-readable micro-labels may be used.

Also, in another cross-media aspect, the ARC device or card itself may contain advertising, further extending the cross-media advertising concept of the system.

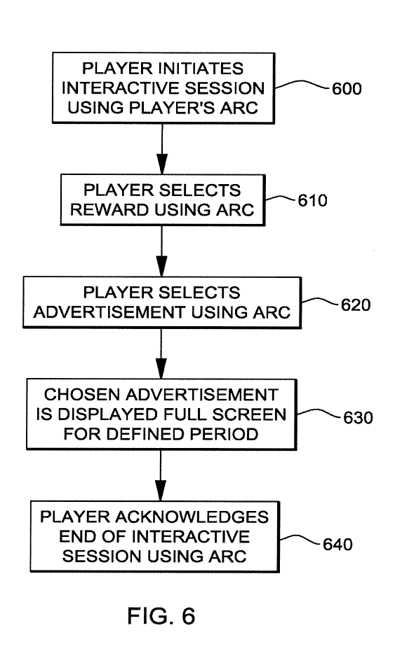

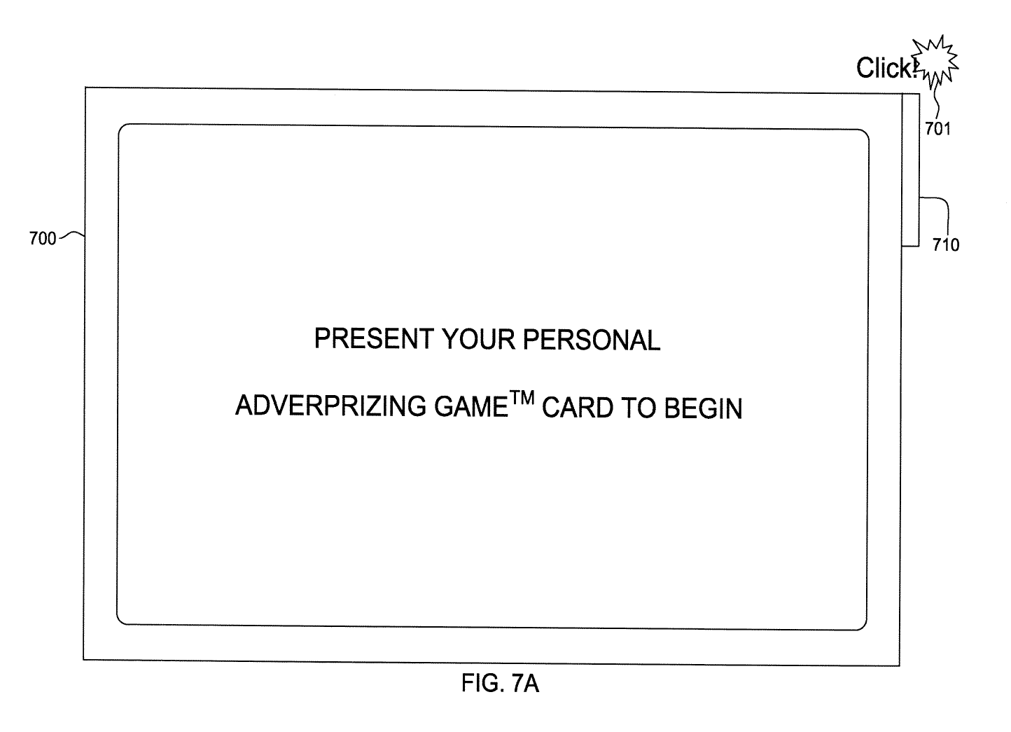

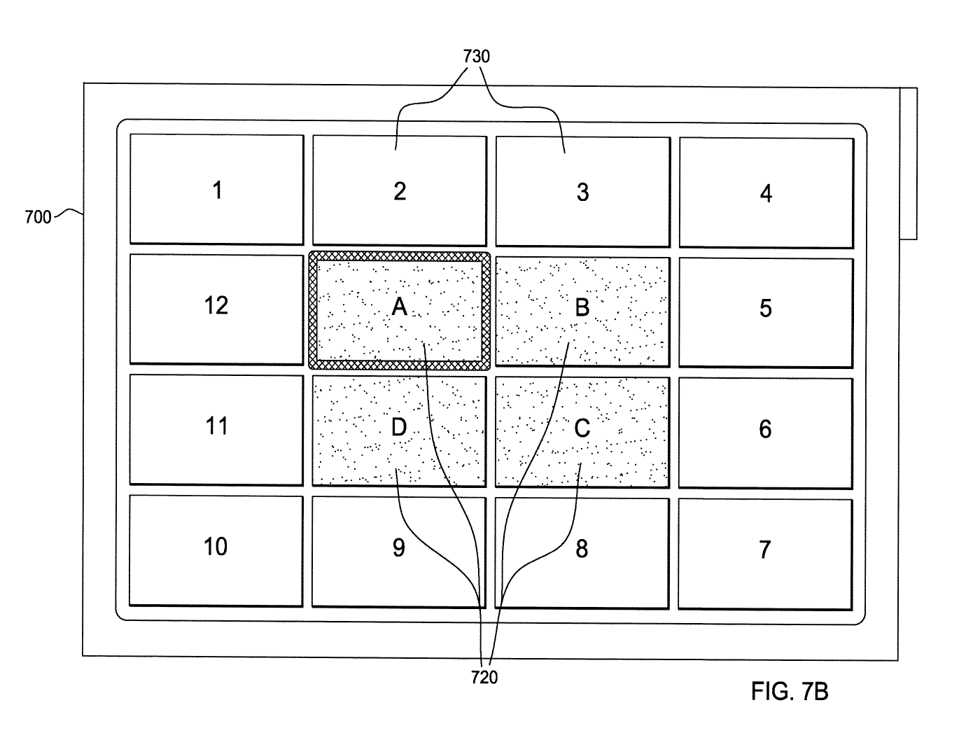

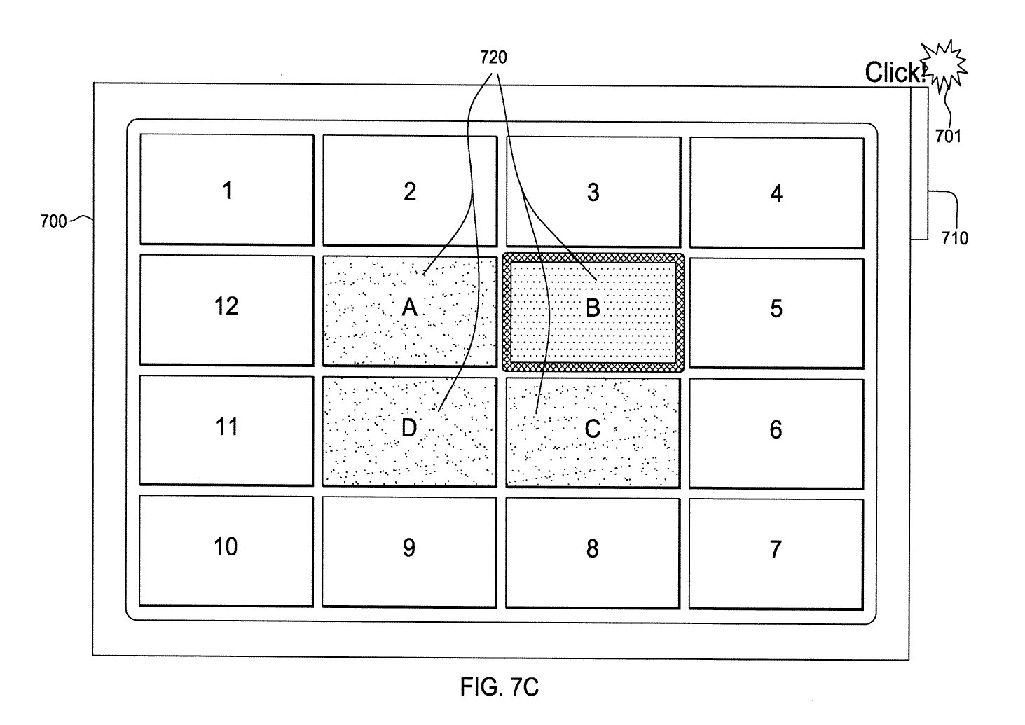

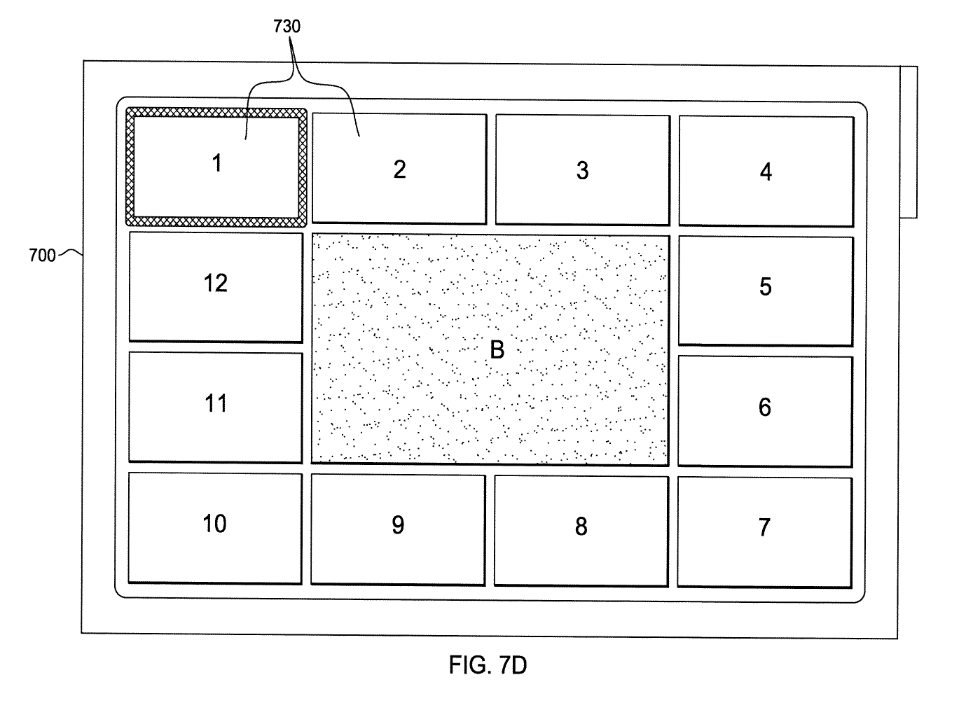

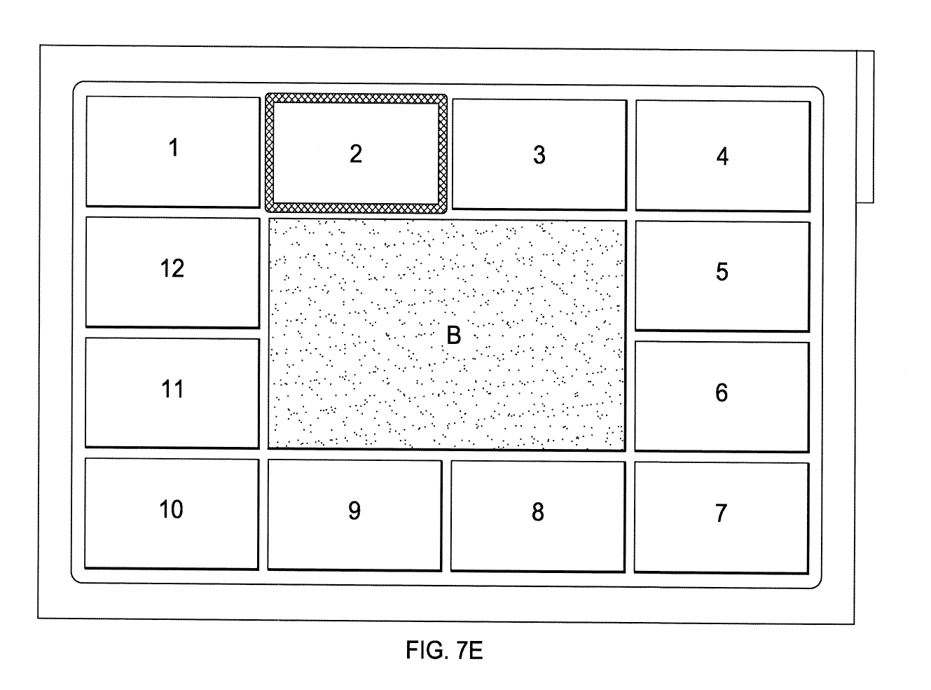

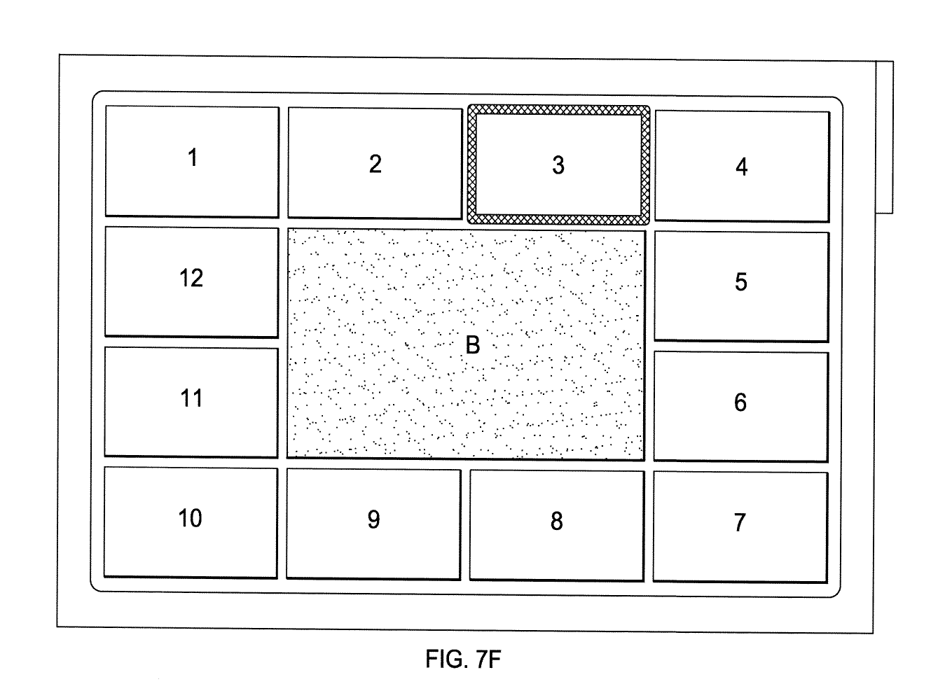

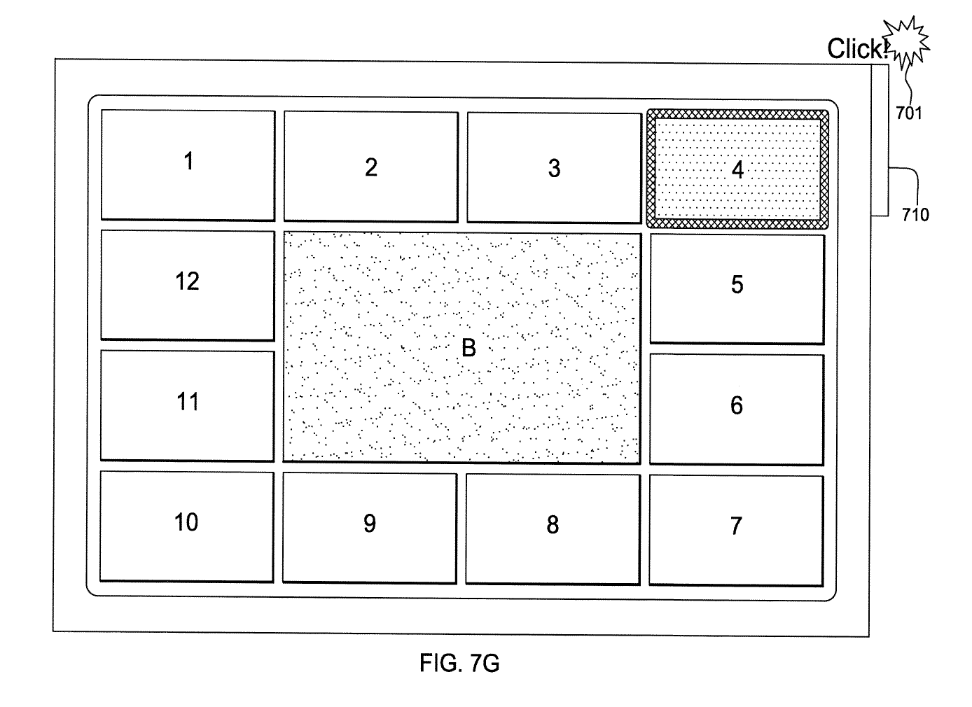

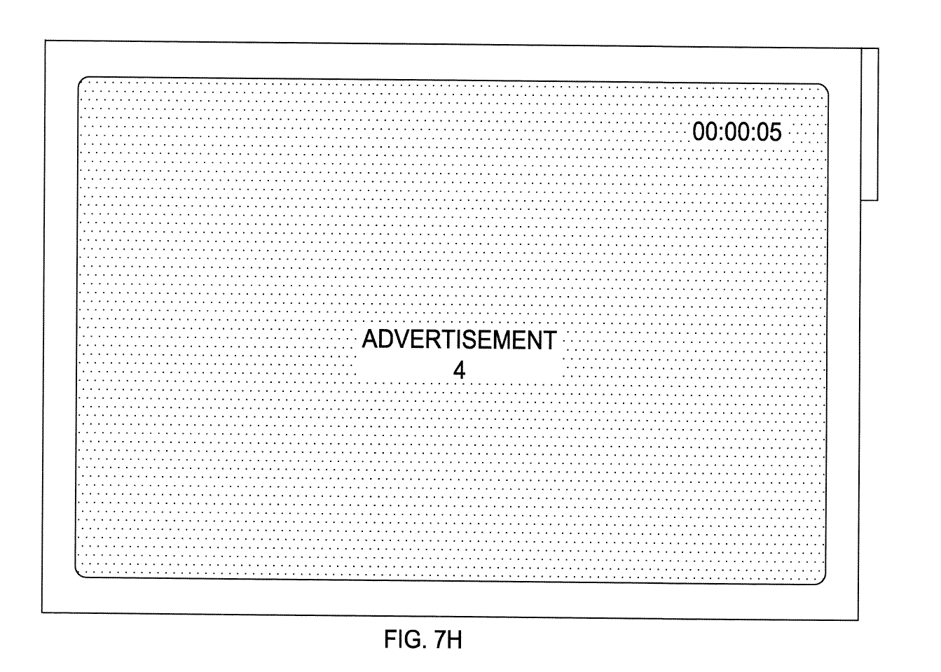

Returning to FIG. 1, a player signals to an interactive digital display terminal using one of the free, predefined ARC cards to begin a player-interaction session with the terminal 140. One embodiment of a player-interaction session with an interactive display terminal is depicted in the flowchart of FIG. 6, and the exemplary display screens of FIGS. 7A-7I, which are described below.

Referring to FIG. 6, a player initiates an interactive session with one of the interactive display terminals using the player's ARC 600. In the above example, it is assumed that the player's ARC is embodied in an RFID card which is identified by an RFID proximity reader associated with the interactive display terminal as the input device for the terminal. Thus, a player initiates an interactive session by, for example, waiving the player's ARC card within the proximity range of the input device. Responsive to this, the terminal's processor may record the ARC, a location identifier of the terminal, the date, and the time of the interactive session as a session data set documenting the interactive session. After the session is initiated, the player selects a reward from multiple rewards displayed on the display screen of the interactive display terminal 610. The selected reward is added to the session data set. The player also selects an advertisement from multiple advertisements displayed in the display screen of the terminal, and the chosen advertisement is added to the session data set being recorded by the terminal. Note that the order of selection of the reward and advertisement may be reversed. The selected advertisement is displayed, in one example, in a different display form factor (such as full screen), for a defined period of time 630. In one example, this defined period of time may be 5 or 6 seconds. After the full format advertisement has been displayed, the player ends the interactive session by again signaling the input device using the player's ARC card 640. The recorded session data set is subsequently forwarded from the interactive display terminal to the central system controller, either individually or collectively with other session data sets of the same or different players.

FIGS. 7A-7I depict one embodiment of a display screen of an interactive display terminal during a player's interactive session with the terminal. In FIG. 7A, display screen 700 is illustrated wherein a player is prompted to present the player's personal ARC card, referred to in this example as an “AdverPrizing Game™” card, to begin an interactive session with the terminal. The “Click!” 701 in the upper right of display screen 700 represents a player having presented their ARC to the terminal's input device 710, by for example, brining their ARC card within a defined proximity of the input device which allows recognition of the ARC card by the input device. In doing so, the player initiates the interactive session with the terminal. Responsive to this, the terminal displays a reward and advertisement data set, such as depicted in FIG. 7B. In this example, four rewards (or products) A, B, C & D 720 are depicted, and twelve advertisements 1 . . . 12 730 are presented. In the embodiment of FIG. 6, the player begins by selecting a reward from the possible rewards. This is accomplished in one approach by the interactive display terminal sequentially highlighting for a defined time period each reward of the multiple rewards 720 until the player selects a particular reward by signaling the terminal using the player's ARC card at the time the particular reward is highlighted. In FIG. 7B, reward A is highlighted, for example, for two or three seconds, while in FIG. 7C, reward B is highlighted. During highlighting of reward B, the player is assumed to bring their ARC within range of the proximity reader (i.e., input device 710) of the terminal, thereby selecting (via the “Click!” 701) reward B. In one implementation, the form factor for the selected reward B is enlarged, as illustrated in FIG. 7D.

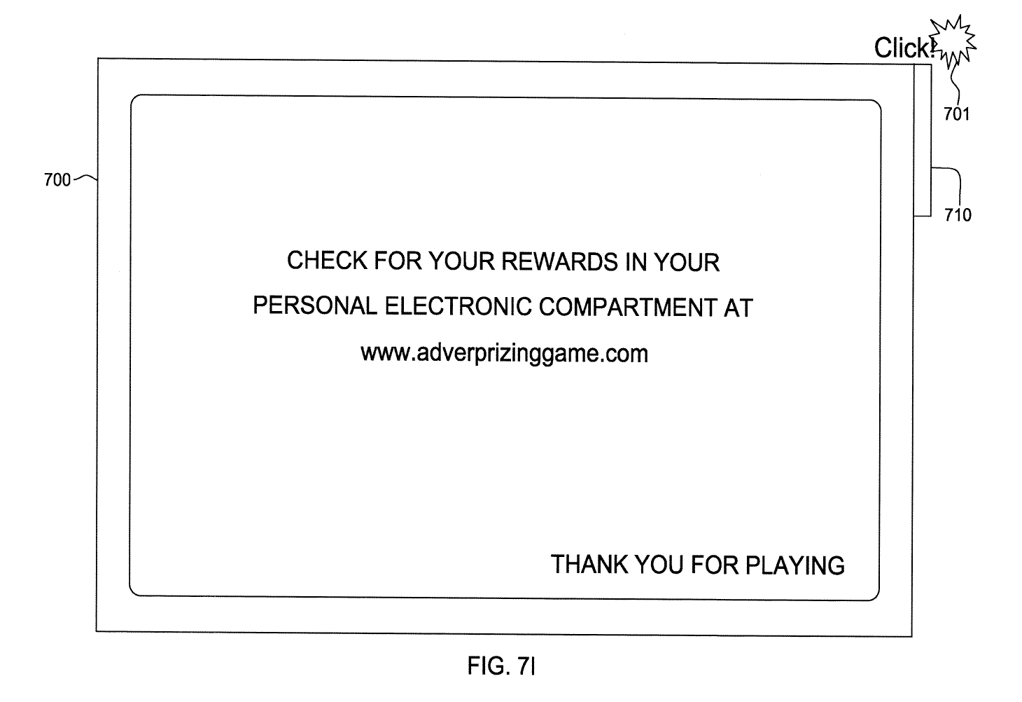

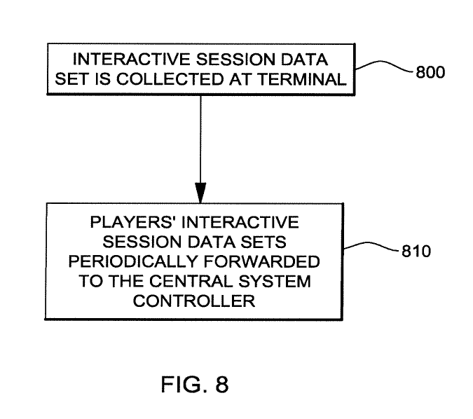

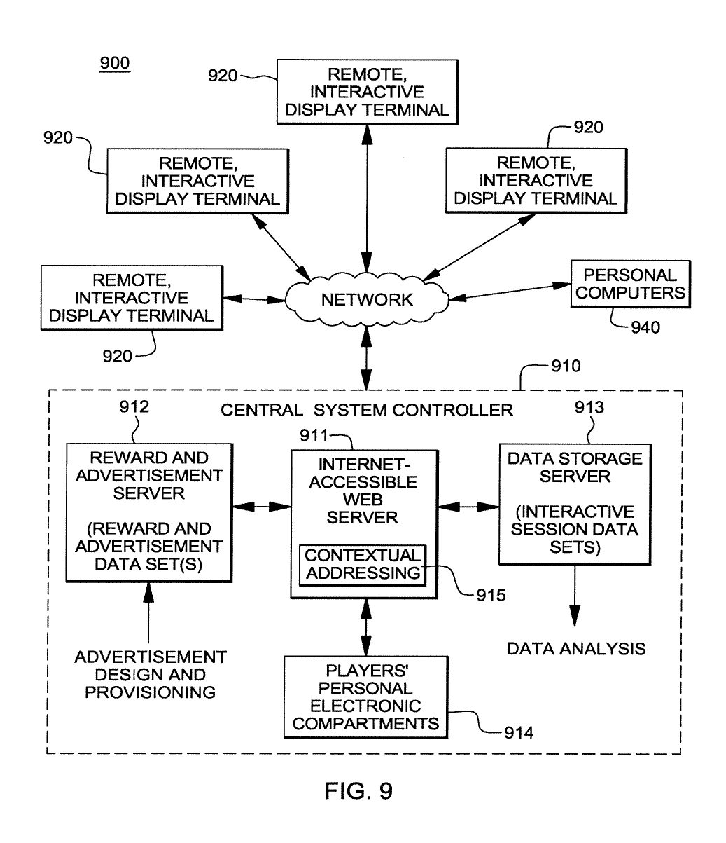

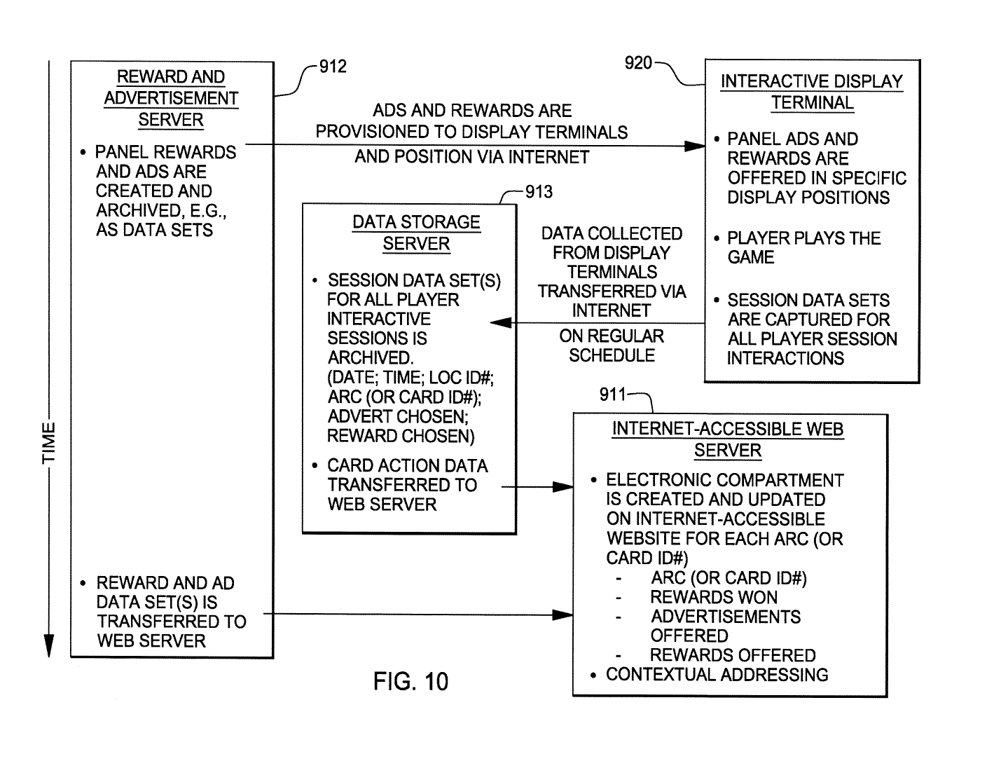

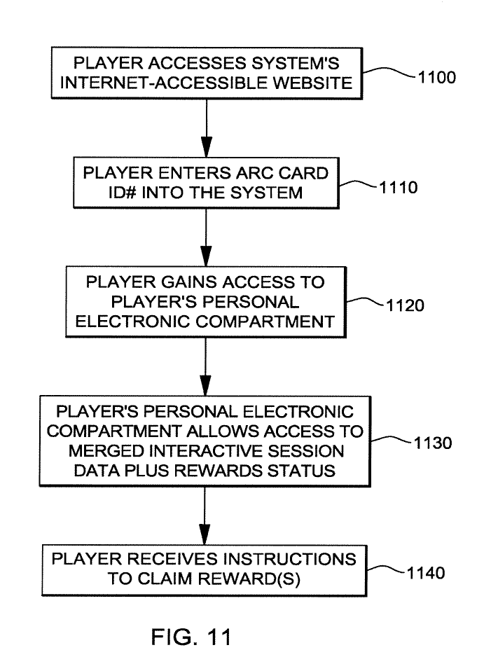

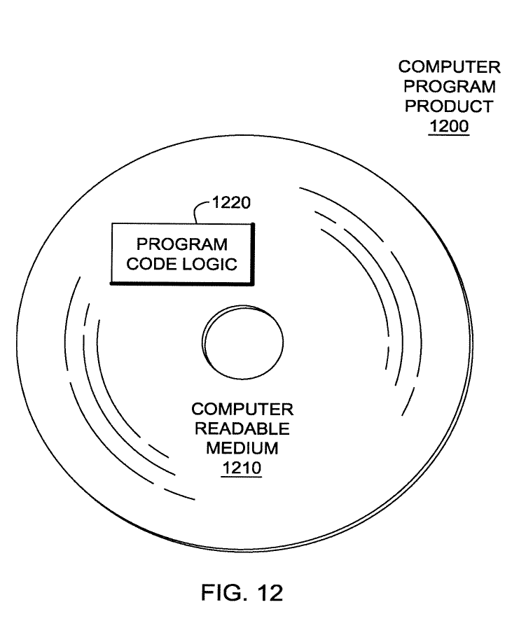

The process repeats for the advertisements, with the interactive display terminal sequentially highlighting for a defined period each advertisement of the multiple advertisements 1 . . . 12 730. In FIG. 7D, advertisement 1 is highlighted, while in FIGS. 7E & 7F, advertisements 2 and 3 are sequentially highlighted. In FIG. 7G, the player is assumed to have brought their ARC card within range of the proximity reader (i.e., input device 710), which results in the selection of highlighted advertisement 4 (via the “Click!” 701). As illustrated in FIG. 7H, the terminal enlarges the selected advertisement to full screen format for a period of time, such as five or six seconds, after which a closing screen is presented as shown in FIG. 71, during which time the player terminates the interactive session by again bringing the player's ARC card within the proximity range of input device 710, resulting in a “Click!” 701, which completes the session. As illustrated in FIG. 71, the closing screen may include a reference to the internet-accessible web site where the system maintains a personal, unique electronic compartment for the player referenced via the player's anonymous recognition code or an identification number associated with the player's anonymous recognition code, e.g., an identification number or alpha-numeric sequence imprinted on the player's ARC card.

Although not depicted in FIGS. 7A-7I, the display screen of the terminal may comprise two distinct display screens, or a single larger screen divided into two screens. By providing two screens, it is possible to customize the reward and advertisement data set displayed within the screens based on gender. In this case, the player would initially select a particular screen with which to engage in an interactive session, and a chosen screen identification could be added to the session data set accumulated by the terminal. Selection of a particular screen could be, for example, achieved utilizing the above-described highlighting approach, wherein one screen is highlighted, then the other, and the player selects a particular screen by signaling the interactive display terminal during highlighting of the particular screen. Alternatively, two input devices could be employed, each associated with a different screen and communication with which results in selection of a particular screen. In this embodiment, the input devices would need to be spaced a sufficient distance to ensure that interaction with one input device using the player's ARC card, would not inadvertently be recognized by the other input device.

Continuing with FIG. 1, the first interactive choice made by a player using a new ARC to start an interactive session results in the system automatically initiating a unique, personal electronic compartment for the player at the internet-accessible system website of the central system controller 120. The system guides and entices the player through a migration, in one embodiment, from interactions with the system through the interactive display terminal, to interactions with the system through virtual entryways to the internet-accessible system website, to the player's private personal electronic compartment accessible through the system website, to the player's virtual private personal linkage display, which allows advertisers to post electronic direct linkages (such as thumbnail sized panels containing graphic and/or text advertisements) to the player, which can be opened or ignored by each individual anonymous addressee.

Players are guided and enticed by knowledge that the player must go through the system entryways to reach their personal electronic compartment, where they can learn if they have won the selected reward. While “within” their private compartment, players can interact with advertisers further through the advertisers' direct linkage display panels in the player's personal linkage display. For example, in one embodiment, the reward and advertisement data set displayed to the player at the interactive display terminal may again be displayed to the player when accessing their personal electronic compartment via the internet-accessible web server. Additional snippets of entertainment, prizes and opportunities may also be offered to players at many sub-sites within the system website. All this functionality is automatically addressable for each player at the moment that the player first plays the game while interacting with one of the interactive display terminals. The emphasis here is on migrating the player to a different type of media platform by requiring the player to access the system web site from, for example, the player's personal home or business computer, in order to ascertain whether the player has won the reward selected. The player is provided with instructions at various places to assist with this cross-media migration and system navigation.

An underlying object of the invention is to stimulate each player by putting the player in a positive, reward-seeking mood while the player is interacting with advertisements on the system. Another goal of the system is to stimulate as many advertisement viewing cycles as possible, whether as part of an interactive session with an interactive display terminal, or as part of a player's interaction with the system through the internet-accessible website of the system, for example, at the player's personal electronic compartment. Further, the system may be configured to encourage media migration of the player from the internet-accessible website back to the physical location where the original interactive display terminal is located, for example, by awarding the player a bonus coupon good at the establishment housing the interactive display terminal.

FIG. 8 is a flowchart of one embodiment of logic implemented by the interactive display terminal(s) of the system. As illustrated, each terminal collects an interactive session data set on each player's respective interactive session with the terminal 800. These interactive session data sets are then periodically transferred to the central server system 810. In one embodiment, each data set includes the player's anonymous recognition code, the location identifier of the interactive display terminal with which the player is interacting, the date that the player interacted with that terminal using the player's anonymous recognition code, the time of day of the interaction, the player-selected reward and the player-selected advertisement.

As an enhancement, a digital image of the player may be obtained via a built-in camera at the interactive display terminal. This digital image could be obtained once when the ARC card is initially used by the player, or, if desired, with each use of the ARC card. The digital image may then be forwarded back to the central system controller, either with the associated interactive session data set, or separate from the data set, but associated with the ARC or an identification number associated with the ARC. Digital impages of the players may be used to manage the reward program, for example, to tailor rewards based on gender or age. By associating a camera with each interactive display terminal, the cameras may also be used for security surveillance. Note that notwithstanding collection of a digital image, the system remains anonymous, in that names, social security numbers, addresses, residential or employment information, phone numbers, etc., are not gathered by the system. If desired, the digital image of the player may be displayed on the display screen while the interactive display terminal is in use by the player, or may be displayed at the player's personal electronic compartment when accessed by the player.

FIG. 9 depicts further aspects of a system, generally denoted 900, in accordance with an aspect of the present invention. System 900 again includes a central system controller 910 and a plurality of interactive display terminals 920, each characterized as described above. System controller 910 is, in one embodiment, a computer or any hardware capable of implementing the features described herein, including one or more personal computers, mainframe computers, etc., which comprise memory and one or more processors. In this embodiment, the interactive display terminals 920 and central system controller 910 are configured to automatically communicate across a network, such as the internet. Central system controller 910 again includes an internet-accessible web server 911 servicing a player-accessible website and the players' personal electronic compartments 914, such as described herein. Players access the internet-accessible website via, e.g., their personal computers 940. Further, a reward and advertisement server 912 and a data storage server 913 are provided in association with the central system controller 910. Reward and advertisement server 912 manages reward and advertisement data sets and provides a facility for advertisement design and provisioning of the reward and advertisement data sets by, for example, a system operator (not shown). Data storage server 913 interfaces with a mass storage unit (not shown) for storage of the interactive session data sets transferred from the plurality of interactive display terminals 920. Data storage server 913 also provides a facility for system operator analysis of the data for, for example, providing feedback to advertisers utilizing the system.

Also illustrated in FIG. 9 is a contextual addressing facility 915 associated with internet-accessible web server 911. Contextual addressing facility 915, which may be a function of internet-accessible web server 911, or alternatively, may be implemented on a separate server which interacts with internet-accessible web server 911, correlates information possible for display in association with a player's personal linkage display(s). For example, a player's direct linkage display may comprise multiple panels which allow (for example) a player to directly access an advertiser's website by selecting a respective one of the panels. This direct linkage display of panels is not an email communication channel with the advertiser, but rather, is a collection of advertisement linkages either previously selected by player or presented to the player through contextual analysis of the player's prior choices, terminal locations visited, or other data accumulated.

The contextual addressing facility described herein has both a data gathering function and a data seeking function. In the data gathering function, the contextual addressing facility collects, correlates, and analyses data, for example, from the interactive session data sets, the reward and advertisement data sets presented to the player(s), and other web server session data sets recorded by the system in association with the players' ARCs. The purpose is to identify personal preferences of each player, or the player's extended family group, based upon selections of the player or group. The contextual addressing facility receives as input interactive session data sets for a player's ARC, reward and advertisement data sets previously viewed by the player using the player's ARC, any relevant extended family or group data sets, etc. In addition, the contextual addressing facility creates internet session files on each player's internet-access to the internet accessible web server using the player's ARC or associated identification code. All of this data is then analyzed to isolate relevant data points as determined, for example, by a database analyst to identify a player's consuming preferences. The contextual addressing facility then selects advertisements that conform to the selected relevant data points and assembles these advertisements in lists or stacks of ad images for group display as advertiser panels in one or more direct linkage displays associated with each player's personal electronic compartment. The contextual addressing facility produces lists and/or displays in individual recoverable form that may be used for marketing purposes or determine relevant ad content for the player interactive displays, private personal compartments, and the personal linkage displays associated therewith.

Data seeking direct and indirect advertisements or queries may also be provided through the contextual addressing facility. For example, a data seeker may a reward that can be won by interactive internet game players accessing the system controller through the internet-accessible web server, or enticements that may generate a recordable response such as a choice to click through to a next step or an embedded website in response to a displayed reward. The data seeking aspect of the contextual addressing facility enables the system operator to direct and place queries and live information probes that can be used for measuring, testing, or obtaining information in connection with one or more interactive display terminals, or the web based system.

Together, the above-described concepts present the potential to yield a compelling competitive advantage for advertisers to reach players potentially interested in their product or service. The contextual addressing facility described herein collects, processes, and transforms otherwise incoherent data related to an anonymous recognition code into data sets that provide new market opportunities and competitive advantages in the form of idiosyncratic coherent data sets that cannot be specifically duplicated with available alternative systems and methods. The contextual addressing facility, or more generally, the central system controller and the plurality of interactive display terminals disclosed herein, provide a novel method of gathering and analyzing data regarding player preferences. The results of the analysis are marketable by the system operator as “linkage lists” which allow advertisers to reach players who may be interested in their product or service, through (for example) the above-described linkage facility associated with a player's personal electronic compartment.

Relational databases and one or more algorithms may be provided by one skilled in the art in order to implement the contextual addressing facility described herein, which as noted, may be implemented in connection with the internet-accessible web server to transform collections of otherwise unrelated heterogeneous data into measurable, usable, and definable indicators of player preferences in relation to potential advertising, sourcing, usage, and purchase of goods or services. In one embodiment, these indicators may be expressed in lists, which may be marketed to potential advertisers. By way of example, the indicators of player preferences may pertain to individual players, or defined groups of players who share a common homogeneity, such as groups of otherwise heterogeneous anonymous players who are recognized as occasionally present at a particular concert, for example, through one or more remote, interactive display terminals located at the concert site. Further, the contextual addressing facility could customize the displays for such terminals based upon the particular event being hosted by the site at that time. For example, a different reward and advertisement data set might be offered to potential players attending a symphony compared with potential players attending a rock concert.

FIG. 10 is a time-based depiction of communications between the various components of the system depicted in FIG. 9. As shown in FIG. 10, the central system controller, or more particularly, the reward and advertisement server 912, forwards panel reward and advertisement data sets to the interactive display terminal(s) 920. The panel rewards and advertisements are displayed in specific positions by display terminal 920, as instructed by the data set received from reward and advertisement server 912. At some later time, a player plays the game employing the player's anonymous recognition code, as described above Interactive display terminal 920 collects session data sets on all player interaction sessions, and these session data sets are automatically transferred, for example, via an internet connection, from the interactive display terminals back to the central system controller, and in particular, to the data storage server 913 thereof. Transfer of session data sets may be via any push or pull communications approach, and may be at any desired interval. Data storage server 913 archives the session data sets for all player interactive sessions with the interactive display terminals. The archived data sets can include, again, the date of the interactive session, the time of day of the interactive session, the location-identifier of the terminal involved, the anonymous recognition code (or an identification number associated with the ARC), the advertisement selected by the player, and the reward selected by the player. The chosen advertisement and chosen reward comprise card action data, which may subsequently be transferred to the internet-accessible web server 911 for association with the player's personal electronic compartment. As noted, the internet-accessible web server 911 automatically initiates the personal electronic compartment for each new ARC used and associates with the player's personal electronic compartment the ARC (or identification number associated with the ARC), any rewards won, identification of advertisements offered at the interactive display terminal during the player's interactive session therewith, and an indication of the rewards that were offered during the player's interactive session with the interactive display terminal. In addition, the above-described contextual addressing facility may be implemented at the internet-accessible web server to collect and sort the data associated with the player's ARC, including both response data and non-response information to arrive at lists which may be displayed in a player's personal linkage display associated with the player's electronic compartment.

Returning to FIG. 1, a player may ascertain the status of a reward choice by going to the system's internet-accessible website, managed by the internet-accessible web server of the central system controller described above. The internet-accessible website 170 includes a player entryway portal, which may contain the player's digital image, assuming that the interactive display terminal implements the digital imaging embodiment described herein. If desired, the entryway portal may be configured to allow a player to choose a password for subsequent entry into the player's personal electronic compartment. This password could be used in place of the ARC, or the identification number associated with the ARC.

Additionally, interactive game rewards may also be provided at the portal each time the player accesses the portal. The entryway image is typically configured to enhance the player's sense of “owning” the virtual compartment in cyberspace. Thus, the design may incorporate features that the player would normally encounter in interacting with the interactive display terminal, and may include functionality that continues the continuity of message, panel sequencing and utilization of enticements to train the player. If desired, advertisers may be permitted to embed web site links in the player's entryway portal area. Upon leaving the player's entryway portal, the player may encounter, for example, an advertiser's directory, or other general website navigation page. Either of these pages could provide a player with an opportunity for more entertainment or rewards. In one implementation, additional passwords may be employed on this page for additional family members or other invitees of the primary player. Thus, each family member or other invitee could have a sub-compartment from the player's primary compartment. The player could then click through to the player's personal electronic compartment, which may take any desired screen layout. Advantageously, by providing family members or other invitees with access to the system through the player's personal electronic compartment, additional players may be obtained for the system. Privacy and security of systemic anonymity for all players, coupled with content control by the system operator, result in a system-specific form of social networking appropriate for any age or gender. The content control responsibility of the system operator is designed to result in age appropriate and non-offensive displays of rewards for each additional player. It is expected that children will tell other children about the fun and entertainment of playing the game system, and that parents will feel comfortable in allowing this activity because the children are anonymous and accessing non-offensive commercial content.

The content displayed in the personal electronic compartment may become more age and gender-specific over time, as the system learns about the player's personal preferences, through, for example, explicit player selections or implicit analytical-derived data, such as the location that the player initially played the game.

As noted above, one or more anonymous direct linkage displays are also provided in association with the player's personal electronic compartment. The linkage panels displayed within the personal electronic compartment may contain embedded websites and embedded instant messaging icons that enable the player to open an advertisement's website or open an instant messaging session with an advertiser without leaving the personal electronic compartment of the internet-accessible website. If desired, “mirror codes” and/or “sister codes” could be used to facilitate anonymous migration of a player off the internet-accessible website to visit other websites in a non-anonymous manner. For example, the system can be configured to allow a player to migrate from their personal electronic compartment to an advertiser's web site for, for example, purchasing a product from the advertiser.

Further, the electronic direct linkage facility described herein allows advertisers to post electronic linkages to individual personal electronic compartments, with the referenced linkages not being e-mail. This is because the addressing functions remain anonymous, and are coordinated with synchronized and demographic and personal preference data, in one embodiment. In another embodiment, checkboxes may be provided to a player at the player's personal electronic compartment that allow the player to view advertisement, entertainment, enticements and opportunities that fit the player's individual interests. A “commercial favorites” list is also accumulated and accessible through the player's personal electronic compartment. Player convenience further is provided by presenting embedded websites and other instant messaging contacts from the advertisers to the players' personal electronic compartments, allowing the players to readily control the advertisements viewed.

FIG. 11 is a flowchart of one process embodiment for a player accessing the player's personal electronic compartment, in accordance with an aspect of the present invention. Initially, the player accesses the system's internet-accessible website 1100 using, for example, any internet-accessible computer or device. The player enters their anonymous recognition code, or the identification number associated with the anonymous recognition code card, into the system 1110. The identification number may be an associated alpha-numeric number imprinted on the ARC card, distributed free of charge to the player. As noted, this identification number could be subsequently replaced with a player's own password after logging into the system website. The player gains access to the player's personal electronic compartment 1120, where the player is allowed access to merged interactive session data plus status on rewards 1130. If the player has won an award, then the player receives instructions on how to claim the reward 1140. For example, in one embodiment, the player may receive an anonymous electronic gift certificate with a unique identification code when the player is notified in their personal compartment that he or she has won the selected reward. The player may copy the certificate and e-mail, or otherwise present the certificate to a reward supplier using communications channels that are not connected to the system. The reward supplier is independent of the system and/or the system operator. Any exchange of personal information required in connection with claiming the reward is therefore unknown to the system and the system operator. The player remains anonymous to the system, but may be known to the reward supplier.

To summarize, the systems and methods described herein incorporate competitive cost effective measures and outcomes as a design goal. There are three perspectives that are useful in evaluating aspects of the invention. These are: the player's perspective, the advertiser's perspective and the system operator's perspective.

From the player's perspective, utilization of the system does not require the purchase of any equipment or subscription. There is no sign-up procedure and no fee charged to the player associated with use of the system. Players are encouraged to use the system in a continuous manner by the constant refreshment of no-risk interactive drawings (or lotteries) for free rewards and give-aways. The system is available for free interactive play in connection with the location-based, interactive display terminals (or signage), and is also available for free interactive play at the central system website, and in the personal electronic compartments that the system automatically initializes and maintains for each individual player corresponding to the player's anonymous recognition code. As an enhancement, players may be allowed to extend the abilities of the system in order for family members and friends to access and play free games through the website. A free electronic direct mail facility is also provided for the player and the player's invitees. The system is designed to be used by the player for brief periods of entertainment and for the development of local market knowledge and access to advertising offers and enticements that can add interest, cost savings and convenience to the player's daily activities. All these benefits are offered and provided to the player, while the player continuously enjoys the benefits of privacy and security associated with being anonymous to the system.

From the advertisers' perspective, utilization of the system for broad categories of advertising business purposes is not restricted to geographic boundaries, market sizes or carrier context. The system is a 24-hour, interactive system that is capable of generating a continuous stream of information and data, including real-time information, about system usage and about commercial preferences of players. In turn, advertisers are able to use the acquired information in order to target messages and content in a highly-granular and micro-targeted fashion in specific places and neighborhoods without sacrificing digital media advantages in color, motion, continuity of message across multiple media-platforms, persistence of messages and content. Players can always react to ads, even in place-based advertising (in one embodiment) Further, the system provides enticement-driven training of players towards the goal of making the advertisers offering a first-reflex-response when the player is considering a purchase within the advertiser's category of offerings.

From the system operator standpoint, numerous social benefits to the system are presented. Further, the possibilities for criminals to conduct identity theft against the player using the system are limited by the nature of the system. The importance of this benefit pertains to both location-based and web-based interactions and is significant as a high-value attribute of the system, including the mail facility, that does not require the use of conventional electronic mail. Further, the proprietary linkage facility described in the system is offered as a substitute for conventional physical direct mail, and therefore, has the potential to eliminate paper waste that is a by-product of today's mass mailings. Emergence of environmentally-conscious “do not mail” lists may provide extra impetus for adoption of the system presented herein. Still further, consumer and governmental concerns about “push” messages and other “interruptive” marketing techniques may lead to the emergence of “do not call” registries, that could impose limits on certain types of mobile and fixed advertising. “Permission-based” messaging is proposed as a partial, common sense solution, but in present form it creates administrative burdens and tracking complexities. In contrast to other advertising approaches that initiate consumer contact via interactions with signage, responsive to the consumer first interacting with the interactive display terminal presented herein, the system automatically initiates a personal electronic compartment for the player that enables advertisers to continue to reach the interactive field of view of the player with a strong continuity of message and persistence of message across multiple media-platforms. The system creates these follow-up advertising capabilities, and follow-up media platforms, in one embodiment, simultaneous with or responsive to, the player's first interactive usage of a terminal via a new anonymous recognition code.

A valuable performance attribute of the system described herein is that the player does not need to possess or utilize any hand-held wireless communications device in order to read follow-up addressing information that may be written or embedded in symbol form in the subject advertising messages. Two recent technologies have entered the marketplace using such an approach. These are: (1) Common Short Codes (CSCs) wherein users possessing wireless devices can key in numbers that are displayed on billboards or other signage and gain access to a mobile website or receive a text message response or download; and (2) Quick Response codes (QR), which are typically 2-D next generation bar codes, embedded in the displayed advertisements, that can be scanned vertically or horizontally, and that can contain more information than CSCs. The information technology addressing schemes of CSC and QR occupy a specific niche within the field of ad messaging. At present, CSC and QR are aimed at generating responses to specific ads, whereas the information technology addressing schemes, organization and architecture of the system and method provided herein provide the player (or consumer) with access to a small, interactive “world”, that is, the game-based advertising system, that is entertaining, and designed to create lasting advertiser/player (or seller/buyer) relationships across a wide range of offerings of products, services and information.

To restate, in order to become eligible to win a reward, the system requires a player to interact with a rapid series of advertising-oriented displays, brand impressions and reward offerings that are individually highlighted for a period of time to indicate that they are temporarily active as choices that can be made by the player. Thus, the digital display screen displays intuitive, non-verbal choices of free rewards and advertisements to the player. The player makes a choice by signaling with the player's ARC card (or other device) a particular choice. The player chooses a reward and an advertisement in each interactive session in order to be qualified to enter into a drawing for the chosen reward. Depending on the communication medium implemented, there is no requirement for the player to be in physical contact with the display screen. Further, there is no requirement for the player to provide personal information to the system or to the advertisers. The player does not gamble with anything or take any risk or make any payment in order to play the game, or qualify to win a reward, such as a gift certificate or other reward associated with the reward provider. Each coupled pair of choices made by a player, that is, the reward choice and advertisement choice, counts as one chance for the player to win the chosen reward. The odds of winning are determined by the number of times that a reward has been chosen by the individual player divided by the number of times that a reward has been chosen by all players during a game cycle. Game cycles may be daily, weekly, monthly, or for any time period selected by the system operator.

Through use of the system, a commercial “favorites list” is created which establishes a relationship between an advertiser and player/consumer through the player's personal electronic compartment, which serves to stimulate business transactions. As noted, the personal electronic compartment provides a facility for advertisers to follow-up with the player. Additionally, virtual direct linkage displays may be accessed through the player's personal electronic compartment. The player can choose to ignore, view and/or store a virtual direct linkage panel from an advertiser within their virtual compartment, and also, the player may interact with these panels and contact the advertisers by utilizing embedded advertiser websites to take the player off the internet-accessible web server of the system to the advertiser's website.

As noted above, the system presented herein includes, in one or more embodiments, communications networks, computers, computerized display screens, monitoring equipment, control equipment, websites, personal electronic compartments via a central system website, signaling devices, sensors, software, electronic advertising displays, interactive computer games that display information and images relating to product and service advertisements and reward advertisers. The system also includes a unique usage of anonymity as an underlying tool, and novel methods of maintaining anonymity in relation to interactive and targeted advertising and reward fulfillment activities. A player is a person who is an advertising target, that is, potential customer. A player plays the interactive electronic game described herein, which is maintained by a system operator, for a primary purpose of displaying advertising, encouraging access to online catalogs, or ordering media, encouraging prolonged viewing of advertising, and making branding impressions on local populations. The system operator is the management organization that is responsible for aspects of the technical operations, contractual obligations and business fulfillment responsibilities in regard to the game system described herein.

Numerous advantages underlie the system and method described herein. For example, the system and method described provide advertisers with integrated, interactive cross-media tool sets that allow players to create commercial “favorites lists”, that is, a list of advertisers, and allows players and advertisers to interact with a built-in ease of connectivity. Realization of this creates an enduring competitive advantage for those commercial advertisers that are added to the commercial “favorites list” of a player. The formatting, connectivity and initial content for each individual “favorites list” may be automatically established, responsive to the player's initial use of an anonymous recognition code at one of the interactive display terminals. This “favorites lists” is only one aspect of the linkage display associated with the initialized personalized electronic compartment for the player. The system essentially activates an advertising relationship management system for each new player upon first interactive contact with one of the interactive display terminals using a new, anonymous recognition code.

Another advantage of the concepts presented herein is the integration of the above-referenced cross-media tool sets along lines that accommodate players' perceptions of being time-starved. The system and method allow players to accumulate and selectively receive information about advertisers in one virtual “place”, while enjoying the privacy of internet anonymity (and enjoying a system-wide shield from intrusive messages) that is provided by a proprietary addressing scheme for each individual consumer that differs from other state of the art contact connectivity features of relationship-based internet advertising.

Another advantage of the system is that players and advertisers connect via the electronic linkage facility described herein, which does not require use of any conventional e-mail to a player's e-mail address. This facility is designed to replace a significant fraction of the physical direct mail that is sent out as “junk mail”. Successful adoption of this system will result in material reduction of environmentally unattractive paper waste product.

A further advantage of the system is that players are provided with personal electronic compartments which contain advertisers' embedded websites that are accessible within the ease of connectivity context that the system provides to the players. A quick-click-through modality for the player's is provided which facilitates transactional follow-up by players who are stimulated into action by the advertisements.

In another aspect, advertisers are provided with system-wide, real-time monitoring, reporting, testing and measurement of advertising applications data. This data allows advertisers to better forecast the cost/benefit balances for advertising programs implemented within the system, and to provide advertisers with highly manageable field laboratory capabilities, wherein trials and experiments can be conducted to test new ad ideas. This feature is supported by the automatic recording of all player interactions with the system across the interactive elements of the system from the moment of first interaction. Thus, the system can provide an advertiser with the ability to review and analyze chains of events from the first contact of a player with an interactive display terminal, to follow-up interactions with the system website and personal compartments, to interactions and responses to electronic direct linkage functions within the personal electronic compartment, to activation of embedded advertiser websites.

In addition, advertisers are potentially provided with channelized access to family units as eventual multi-party system users are developed from a player's personal electronic compartment. This provides a multiplier effect from each initial player, and a level of downstream semi-social networking that is focused on the commercial advertising purposes of the system. In this context, the system is designed to impel players to encourage family members and additional invitees to play the game.

In a further aspect, the system provides advertisers with the advantage of providing a medium where individual elements of ad images, text or sound can be changed over a network, at a granular level, at reasonable cost. This provides improved ability to market individual interactive advertising panels as an asset class in alternative locations, where local advertisements that target a micro-population within a small geographic footprint are financially practical.

As presented herein, the system and method disclosed provide advertisers with a systematic, inexpensive way of acquiring place-based relationships with micro-targeted, anonymous consumers, acquiring web-based relationships with the same consumers, acquiring addressed electronic linkage relationships with the same consumers, learning about the interest and buying appetites of anonymous players in a non-intrusive fashion, and learning answers to specific questions about preferences of anonymous customers and customer groups by using entertaining, system-enabled “data seekers”. This facilitates highly measurable and dependably sustainable development of customer relationships.

As an optional feature, the system may be designed such that the interactive display terminal captures a facial digital image of all players. Further, the ARC card provided to a player may contain an indicator of point of origin of the card that is machine-readable by the system operator. This information may then be used in connection with knowledge of neighborhoods, venues and commuting traffic patterns to inform advertisers in relation to their micro-targeting efforts. The power of this system-created utility can apply to a single venue, multiple similar venues within a neighborhood, to groups of venues within a geographic region, or to a national advertising campaign. As an example of this, a manufacturer of a specialized memorabilia might take advantage of the system to reach targeted audience when the U.S. is visited by an Italian Pope, or when a Brazilian soccer team wins an international event. It is noteworthy that the system provides advertisers with unique advantages in the form of mechanisms to rapidly spread advertising messages and brand impressions. These mechanisms are coupled with the persistent presence of multiple media formats, and are suitable for high-speed, micro-targeted updating of content. The system accomplishes this, in part, using numerous built-in attractions and entertainment features.

One or more aspects of the present invention can be included in a computer program product to facilitate one or more aspects of the present invention. The computer program product includes a storage medium readable by a processing circuit and storing instructions for execution by the processing circuit for performing one or more of the capabilities of the present invention.

In one example, an article of manufacture (e.g., one or more computer program products) having, for instance, computer readable media includes one or more aspects of the present invention. The media has therein, for instance, computer readable program code means or logic (e.g., instructions, code, commands, etc.) to provide and facilitate the capabilities of the present invention. The article of manufacture can be included as a part of a computer system or sold separately.

One example of an article of manufacture or a computer program product incorporating one or more aspects of the present invention is described with reference to FIG. 12. A computer program product 1200 includes, for instance, one or more computer usable media 1210 to store computer readable program code means or logic 1220 thereon to provide and facilitate one or more aspects of the present invention. The medium can be an electronic, magnetic, optical, electromagnetic, infrared, or semiconductor system (or apparatus or device), as examples. Examples of a computer readable medium include a semiconductor or solid state memory, magnetic tape, a removable computer diskette, a random access memory (RAM), a read-only memory (ROM), a rigid magnetic disk and an optical disk. Examples of optical disks include compact disk-read only memory (CD-ROM), compact disk-read/write (CD-R/W) and DVD.

A sequence of program instructions or a logical assembly of one or more interrelated modules defined by one or more computer readable program code means or logic direct the performance of one or more aspects of the present invention.

Although various embodiments are described above, these are only examples.

Further, a data processing system suitable for storing and/or executing program code is usable that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I10 devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The capabilities of one or more aspects of the present invention can be implemented in software, firmware, hardware, or some combination thereof. At least one program storage device readable by a machine tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted, or modified. All of these variations are considered a part of the claimed invention.

Although embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A system comprising:
a system controller comprising memory and at least one processor, the system controller including an internet-accessible web server servicing an internet-accessible website, and the system controller being configured for automatic communications with at least one interactive display terminal disposed geographically remote from the system controller; and
wherein responsive to a player's first interaction with an interactive display terminal of the at least one interactive display terminal using an anonymous recognition code of a plurality of predefined anonymous recognition codes, the system controller automatically initiates a personal electronic compartment accessible through the internet-accessible web sever corresponding to the player's anonymous recognition code, and associates therewith a location identifier of the interactive display terminal at which the anonymous recognition code was first used, wherein the personal electronic compartment is player-accessible via the internet, through the internet accessible website serviced by the internetaccessible web server of the system controller.

2. The system of claim 1, wherein the personal electronic compartment is player-accessible, via the internet, other than through the at least one interactive display terminal using, at least in part, one of the player's anonymous recognition code or a predefined identification code associated with the player's anonymous recognition code.

3. The system of claim 1, wherein the system controller automatically obtains at least one session data set from the interactive display terminal on the player's interaction session with the interactive display terminal and associates the at least one session data set with the automatically-initiated, personal electronic compartment corresponding to the player's anonymous recognition code, and accessible through the internet-accessible website.

4. The system of claim 1, wherein the system controller facilitates third-party electronic communication with the player via the player's automatically-initiated, personal electronic compartment corresponding to the player's anonymous recognition code, and an anonymous direct linkage facility to the player's personal electronic compartment provided by the system controller.

5. The system of claim 1, further comprising the at least one interactive display terminal, the at least one interactive display terminal being configured for automatic communication with the system controller, and comprising a display screen, and wherein the system is a game-based advertising system, the at least one interactive display terminal being configured to present on the display screen, responsive to actuation thereof by only the player's anonymous recognition code, a reward and advertisement data set for player selection of a reward of multiple rewards and an advertisement of multiple advertisements using only the player's anonymous recognition code.

6. The system of claim 5, wherein the at least one interactive display terminal is configured to record at least one session data set on the player's interaction session therewith, the at least one session data set comprising the player's anonymous recognition code, the location identifier of the interactive display terminal, the date that the player interacted with the interactive display terminal using the player's anonymous recognition code, the player selected reward and the player selected advertisement, and wherein the at least one session data set is subsequently automatically transferred to the system controller for association with the personal electronic compartment corresponding to the player's anonymous recognition code, and accessible through the internetaccessible web site.

7. The system of claim 6, wherein the reward and advertisement data set comprises multiple rewards and multiple advertisements, and wherein the interactive display terminal is configured for the player to select one reward of the multiple rewards and one advertisement of the multiple advertisements using only the player's anonymous recognition code, and the system controller further associates the reward and advertisement data set with the at least one session data set automatically transferred from the interactive display terminal, the reward and advertisement data set having been previously automatically downloaded from the system controller to the interactive display terminal.

8. The system of claim 5, wherein the interactive display terminal is configured to sequentially highlight for a first defined time period each reward of the multiple rewards of the reward and advertisement data set until the player selects one highlighted reward of the multiple rewards using only the player's anonymous recognition code, and to sequentially highlight each advertisement of the multiple advertisements of the reward and advertisement data set for a second defined time period until the player selects one highlighted advertisement of the multiple advertisements using only the player's anonymous recognition code.

9. The system of claim 8, wherein selection of the one advertisement by the player results in the interactive display terminal enlarging a display form factor of the one advertisement on the display for a third defined time period.

10. The system of claim 5, wherein the at least one interactive display terminal is configured to capture a digital image of the player interacting therewith via the player's anonymous recognition code, and to associate the digital image with the player's anonymous recognition code for automatic transfer to the system controller for association with the personal electronic compartment corresponding to that player's anonymous recognition code, and accessible through the internet-accessible website.

11. The system of claim 5, wherein the player interacts with the interactive display terminal wirelessly using only the player's anonymous recognition code.

12. A system comprising:
an interactive display terminal configured for player interaction therewith via an anonymous recognition code of a plurality of predefined anonymous recognition codes, the interactive display terminal comprising a display screen and an input device configured to recognize the player's anonymous recognition code for player interaction with the interactive display terminal, wherein the player communicates with the input device of the interactive display terminal using only the player's anonymous recognition code, and wherein the interactive display terminal is configured for player selection of a reward employing the input device and the player's anonymous recognition code, and for player selection of an advertisement using the input device and the player's anonymous recognition code, the reward being one reward of multiple rewards of a reward and advertisement data set presented to the player on the display screen and the advertisement being one advertisement of multiple advertisements of the reward and advertisement data set; and
wherein responsive to the player's selection of the reward and selection of the advertisement, the interactive display terminal automatically associates the player's anonymous recognition code with the selected reward in a session data set, and displays for a period of time the selected advertisement on the display screen.

13. The system of claim 12, wherein the interactive display terminal sequentially highlights for a first period of time each reward of the multiple rewards of the reward and advertisement data set until the player selects a highlighted reward by signaling the input device using the player's anonymous recognition code while that reward is highlighted, and wherein the interactive display terminal sequentially highlights, for a second period of time, each advertisement of the multiple advertisements of the reward and advertisement data set until the player selects a highlighted advertisement by signaling the input device using the player's anonymous recognition code while that advertisement is highlighted.

14. The system of claim 12, further comprising a plurality of interactive display terminals geographically dispersed, and wherein the player initiates an interactive session with any interactive display terminal of the plurality of interactive display terminals by only signaling to the interactive display terminal's input device using the player's anonymous recognition code.

15. The system of claim 12, wherein the displaying for the period of time the selected advertisement on the display screen comprises changing form factor of the selected advertisement to substantially fill the display screen for the period of time.

16. The system of claim 12, wherein the interactive display terminal automatically transfers to a central system controller at least one session data set on the player's interaction session with the interactive display terminal, the at least one session data set comprising the player's anonymous recognition code, a location-identifier of the interactive display terminal, the date the player interacted with the interactive display terminal using the player's anonymous recognition code, the player-selected reward and the player-selected advertisement.

17. The system of claim 12, wherein the player communicates wirelessly with the input device of the interactive display terminal using the player's anonymous recognition code.

18. The system of claim 12, wherein the interactive display terminal further comprises a camera to capture a digital image of the player interacting therewith using the player's anonymous recognition code, the interactive display terminal associating the digital image with the player's anonymous recognition code for automatic transfer to a central system controller of the system.

19. A system comprising:
a plurality of interactive display terminals configured for players to interact therewith via respective anonymous recognition codes of a plurality of predefined anonymous recognition codes, each interactive display terminal of the plurality of interactive display terminals being configured to record a session data set on a player's interaction session therewith using the player's respective anonymous recognition code, the session data set comprising the player's anonymous recognition code, a location identifier of the interactive display terminal, a reward selected by the player from multiple displayed rewards of a reward and advertisement data set and an advertisement selected by the player from multiple displayed advertisements of the reward and advertisement data set; and
a central system controller comprising an internet-accessible web server servicing an internet-accessible website, the central system controller and the plurality of interactive display terminals being configured for automatic communications therebetween, wherein session data sets accumulated at the plurality of interactive display terminals are automatically transferred to the central system controller, and wherein players access data of their session data sets via respective, personal electronic compartments accessible through the internet-accessible website serviced by the internet-accessible web server.

20. The system of claim 19, wherein the central system controller automatically initiates a personal electronic compartment accessible through the internetaccessible web site corresponding to a new player's respective, anonymous recognition code responsive to the player's first use of the respective, anonymous recognition code, and wherein the central system controller automatically associates a session data set, collected from the new player's interaction with the interactive display terminal, with the player's personal electronic compartment corresponding to the player's anonymous recognition code.

21. The system of claim 19, wherein the plurality of interactive display terminals are geographically dispersed, and wherein a player initiates an interactive session with one interactive display terminal of the plurality of interactive display terminals using only the player's anonymous recognition code.

22. The system of claim 19, wherein the central system controller further comprises a reward and advertisement server comprising reward and advertisement data sets for the plurality of interactive display terminals, and wherein upon transfer of a session data set to the central system controller, the reward and advertisement data set displayed to the player during the player's interaction session with the interactive display terminal collecting the session data set is associated with the received session data set for subsequent retrieval by the player via the player's personal electronic compartment accessible through the internet-accessible website using one of the player's respective, anonymous recognition code or a predefined identification number associated with the player's respective, anonymous recognition code.

23. A method comprising:
providing a central system controller comprising memory and at least one processor, the central system controller including an internet-accessible web server configured to service an internet-accessible system web site, and the central system controller being configured for automatic communications with a plurality of interactive display terminals;
geographically dispersing the plurality of interactive display terminals, wherein each interactive display terminal is configured to record a session data set on each player interaction session therewith via a respective anonymous recognition code of a plurality of predefined anonymous recognition codes, each session data set comprising the player's anonymous recognition code, a location-identifier of the interactive display, a reward selected by the player from multiple displayed rewards of a reward and advertisement data set and an advertisement selected by the player from multiple displayed advertisements of the reward and advertisement data set; and
wherein session data sets accumulated by the plurality of interactive display terminals are automatically transferred to the central system controller, and players access data of their session data sets via respective, personal electronic compartments corresponding to their anonymous recognition codes, and accessible through the internet-accessible web server of the central system controller.
